(19) United States
(12) Patent Application Publication
(10) Pub. No.: US 2015/0168774 A1
(43) Pub. Date: Jun. 18, 2015

(54) DISPLAY DEVICE AND TELEVISION RECEIVER

(71) Applicant: Sharp Kabushiki Kaisha, Osaka (JP)

(72) Inventor: Mitsuru Hosoki, Osaka (JP)

(73) Assignee: Sharp Kabushiki Kaisha, Osaka (JP)

(21) Appl. No.: 14/408,048

(22) PCT Filed: Jun. 14, 2013
(86) PCT No.: PCT/JP2013/066441

§ 371 Date: Dec. 15, 2014

(30) Foreign Application Priority Data
Jun. 21, 2012 (JP) 2012-139902

(51) Int. Cl. G02F 1/1335; H04N 5/44; G09G 3/20; F21V 8/00

(52) U.S. Cl. CPC G02F 1/133514; G02F 1/1336; G02B 6/0073; H04N 5/44; G09G 3/2003

(57) ABSTRACT

Provided is a liquid crystal display device that includes: a liquid crystal panel that includes red pixels that selectively transmit red light, blue pixels (BPX) that selectively transmit blue light, and green pixels that transmit at least green light; a backlight device that includes magenta LEDs and green LEDs; a panel control unit that controls the liquid crystal panel in such a manner that one frame display period includes a red-and-blue display period in which the red pixels and the blue pixels are selectively driven so as to carry out display in red and blue, and a green display period in which the green pixels are selectively driven so as to carry out display in green; and a backlight control unit that controls the backlight device in such a manner that the backlight device turns on the magenta LEDs and turns off the green LEDs during the red-and-blue display period, and turns on the green LEDs and turns off the magenta LEDs during the green display period.

### TECHNICAL FIELD

The present invention relates to a display device and a television receiver.

### BACKGROUND ART

In recent years, flat panel display devices that use flat panel display elements such as liquid crystal panels and plasma display panels are increasingly used as display elements for image display devices such as television receivers instead of conventional cathode-ray tube displays, allowing image display devices to be made thinner. Liquid crystal panels used in liquid crystal display devices do not emit light on their own, and thus, require a separately provided backlight device as an illumination device, and backlight devices that use LEDs as the light source are known, an example of which is disclosed in Patent Document 1 below.

### RELATED ART DOCUMENTS

### Patent Documents

Patent Document 1: Japanese Patent Application Laid-Open Publication No. 2010-113125

### Problems to be Solved by the Invention

In Patent Document 1, the liquid crystal panel is provided with yellow sub-pixels having yellow color filters and cyan sub-pixels that have cyan color filters, while the backlight device includes red LEDs that emit red light, green LEDs that emit green light, and blue LEDs that emit blue light. During a first driving period, the red LEDs and the blue LEDs are illuminated while driving the yellow sub-pixels and the cyan sub-pixels, while during a second driving period, the green LEDs are illuminated while driving the yellow sub-pixels and the cyan sub-pixels, thereby increasing the duty ratio and increasing light usage efficiency compared to the conventional field sequential method.

However, green light can pass through yellow sub-pixels and cyan sub-pixels, and thus, during the first driving period, light having a wavelength towards green included in light emitted from the red LEDs and blue LEDs passes through the yellow sub-pixels and cyan sub-pixels, which can worsen color reproduction. Similarly, yellow sub-pixels allow red light through, and cyan sub-pixels allow blue light through, which means that during the second driving period, light having a wavelength towards red and light having a wavelength towards blue included in the light emitted by the green LEDs and passes through the yellow sub-pixels and the cyan sub-pixels, which can worsen color reproduction. Also, there is a need to manufacturing specially designed liquid crystal panels provided with yellow and cyan color filters, and liquid crystal panels having conventional general use red, green, and blue color filters cannot be used, which increases manufacturing cost.

### SUMMARY OF THE INVENTION

The present invention was made in view of the above-mentioned situation, and an object thereof is to improve color reproduction.

### Means for Solving the Problems

A display device of the present invention includes: a display panel, for displaying images, having red pixels that selectively allow through red light, blue pixels that selectively allow through blue light, and green pixels that selectively allow through at least green light; an illumination device for supplying light for image display to the display panel, the illumination device having magenta light sources that emit magenta light, and green light sources that emit green light; a panel control unit that controls the display panel such that each frame period includes a red-and-blue display period during which the red pixels and the blue pixels are selectively driven to display red and blue, and a green display period during which the green pixels are selectively driven to display green; and an illumination control unit that controls the illumination device such that the magenta light sources are turned on and the green light sources are turned off during the red-and-blue display period, and such that the green light sources are turned on and the magenta light sources are turned off during the green display period.

In this manner, during the red-and-blue display period included in each frame period, the red pixels and the blue pixels are selectively driven by the panel control unit and the illumination control unit turns ON the magenta light sources while turning OFF the green light sources. When this happens, the magenta light emitted by the magenta light sources passes through the red pixels driven in the display panel resulting in red transmitted light, and passes through the driven blue pixels resulting in blue transmitted light, allowing red and blue display. At this time, the green light sources are turned OFF and thus, the color purity of the light transmitted through the red pixels and the blue pixels is high. Furthermore, the red pixels selectively allow through red light and the blue pixels selectively allow through red light, and almost no light of other colors (such as green light) passes therethrough, and thus, the color purity of the transmitted light can be made higher.

During the green display period included in each frame period, the green pixels are selectively driven by the panel control unit, and the illumination control unit turns ON the green light sources while turning OFF the magenta light sources. When this happens, the green light emitted by the green light sources passes through the green pixels in the display panel, causing green to be displayed. At this time, the magenta light sources are turned OFF, and thus, the color purity of light transmitted through the green pixels is high.

By including the red-and-blue display period and the green display period in each frame period as described above, it is possible to display images in the display panel with the images having a high color reproduction. Also, color display is performed by including two types of display periods including the red-and-blue display period and the green display period in each frame period, and thus, compared to a case in which each frame period included three or more display periods, the duty ratio for each display period can be made high, which allows the panel control unit to control the display panel with ease and allows the illumination control unit to control the illumination device with ease.

As embodiments of the present invention, the following configurations are preferred.

(1) The green pixels selectively allow through green light. In this manner, the display panel includes red pixels, green pixels, and blue pixels that selectively allow through light of the three primary colors, and thus, it is possible to use a general use display panel, which is advantageous for cost. The green pixels selectively allow through green light and do not allow through light of other colors (such as red light or blue light), and thus, it is possible to make the color purity of the light transmitted through the green pixels during the green display period high, which allows excellent color reproduction.

(2) The magenta light sources each have a blue light-emitting element that emits blue light and a red phosphor that emits red light by being excited by the blue light emitted by the blue light-emitting element. In this manner, compared to a case in which the magenta light sources are constituted of a group of red light sources that emit red light and blue light sources that emit blue light, the control circuit of the magenta light sources of the illumination control unit is simpler, and the driving of the magenta light sources also becomes simpler. Also, the light emitted by the magenta light sources is magenta light in which the red light and the blue light are mixed together, which mitigates the occurrence of so-called color breakup.

(3) The green light sources each have a green light-emitting element that emits green light, and the green light-emitting element in each of the green light sources is made of a same semiconductor material as the blue light-emitting element in each of the magenta light sources. In this manner, the drive voltage is approximately the same for the green light-emitting elements and the blue light-emitting elements, and thus, a common power source can be used for the illumination control unit for driving the green light sources and the magenta light sources. Furthermore, the temperature characteristics of the green light-emitting elements and the blue light-emitting elements are similar, and thus, color unevenness resulting from chromaticity change in emitted light due to temperature change is mitigated.

(4) The semiconductor material is InGaN. This allows for good light-emission efficiency and low manufacturing cost.

(5) The display panel has a plurality of the red pixels, the green pixels, and the blue pixels arranged in a matrix, and the panel control unit sequentially scans, in a column direction, groups of pixels including the red pixels, the green pixels, and the blue pixels arranged in a row direction on the display panel, the display panel is divided into at least two regions including a first region that is relatively close in the column direction to where scanning starts and a second region that is relatively far in the column direction from where scanning starts, and the magenta light sources and the green light sources in the illumination device are separated into at least two types including first magenta light sources and first green light sources that supply light to the first region in the column direction, and second magenta light sources and second green light sources that supply light to the second region, the illumination control unit turns off the first magenta light sources and the first green light sources from when scanning of the red pixels and the blue pixels or the green pixels belonging to the first region starts to when the scanning ends during the red-and-blue display period or the green display period, while the illumination control unit turns on the first magenta light sources or the first green light sources and turns off the first green light sources or the first magenta light sources from when the scanning ends to when scanning starts during the subsequent green display period or the subsequent red-and-blue display period, and the illumination control unit turns off the second magenta light sources and the second green light sources from when scanning of the red pixels and the blue pixels or the green pixels belonging to the second region starts to when the scanning ends during the red-and-blue display period or the green display period, while the illumination control unit turns on the second magenta light sources or the second green light sources and turns off the second green light sources or the second magenta light sources from when the scanning ends to when scanning starts during the subsequent green display period or the subsequent red-and-blue display period.

In this manner, during the red-and-blue display period, the panel control unit sequentially scans, in the column direction, groups of pixels including the red pixels, the green pixels, and the blue pixels arranged in the row direction, thereby selectively driving the red pixels and the blue pixels. Here, during the period from when scanning of the red pixels and the blue pixels belonging to the first region starts during the red-and-blue display period to when the scanning ends, both the first magenta light sources and the first green light sources are turned OFF, and during the period from when the scanning ends until the subsequent green display period starts, the first magenta light sources are turned ON and the first green light sources are turned OFF. Next, during the period from when scanning of the red pixels and the blue pixels belonging to the second region starts during the red-and-blue display period to when the scanning ends, both the second magenta light sources and the second green light sources are turned OFF, and during the period from when the scanning ends until the subsequent green display period starts, the second magenta light sources are turned ON and the second green light sources are turned OFF.

On the other hand, during the green display period, the panel control unit sequentially scans, in the column direction, groups of pixels including the red pixels, the green pixels, and the blue pixels arranged in the row directions, thereby selectively driving the green pixels. Here, during the period from when the scanning of the green pixels belonging to the first region starts during the green display period to when the scanning ends, the first green light sources and the first magenta light sources are both turned OFF, and during the period from when this scanning ends until the scanning of the subsequent red-and-blue display period starts, the first green light sources are turned ON and the first magenta light sources are turned OFF. Next, during the period from when the scanning of the green pixels belonging to the second region starts during the green display period to when the scanning ends, the second green light sources and the second magenta light sources are both turned OFF, and during the period from when this scanning ends until the scanning of the subsequent red-and-blue display period starts, the second green light sources are turned ON and the second magenta light sources are turned OFF.

As described above, during the period from when the scanning in each regions starts to when the scanning ends, the light sources that can supply light to the regions being scanned are turned OFF, and thus, light can be prevented from being supplied to the respective pixels in the middle of scanning. In this manner, it is possible to maintain high color purity for light transmitted through the pixels, and color reproduction can be further improved. This is particularly suited to when the display panel has a large screen size.

(6) In the illumination device, a plurality of the magenta light sources and a plurality of the green light sources are arranged in a matrix such that respective light-emitting surfaces thereof face a surface of the display panel, the plurality of magenta light sources and a plurality of the green light sources being arranged along the surface, and the magenta light sources and the green light sources are arranged such that the first magenta light sources and the first green light sources correspond in position to the first region in a plan view, and such that the second magenta light sources and the second green light sources correspond in position to the second region in a plan view. In this manner, light can be efficiently supplied from the first magenta light sources and the first green light sources corresponding in position to the first region in a plan view, and it is unlikely for this light to be mixed with light from the second magenta light sources and the second green light sources. Similarly, light can be efficiently supplied from the second magenta light sources and the second green light sources corresponding in position to the second region in a plan view, and it is unlikely for this light to be mixed with light from the first magenta light sources and the first green light sources. As a result, light from the respective light sources can be selectively supplied to the respective regions. This is particularly useful when dividing the display panel into many regions.

(7) The display panel is divided into three or more regions in the column direction, and in the illumination device, the magenta light sources and the green light sources are separated into three or more types that respectively supply light to the three or more regions of the display panel. In this manner, compared to a case in which the display panel is divided into two regions, the illumination period for the respective set of light sources supplying light to the respective regions on the display panel is longer, and thus, the luminance can be improved.

(8) The panel control unit includes an image signal processing circuit that processes image signals, a pixel driving unit that drives the red pixels, the green pixels, and the blue pixels on the basis of signals outputted from the image signal processing circuit, and a frame rate conversion circuit that can convert a frame rate of the signals outputted from the image signal processing circuit and supply the signals to the pixel driving unit. In this manner, the frame rate of the signal outputted by the image signal processing circuit is converted by the frame rate conversion circuit and then supplied to the pixel driving unit, and thus, it is possible to perform driving in which each frame period includes a red-and-blue display period and a green display period. A general use double-speed driver circuit can be used as the frame rate conversion circuit, for example, which is advantageous from the perspective of reducing cost.

(9) The display panel includes a substance between a pair of substrates that changes optical properties in response to an applied electric field, and either one of the pair of substrates has color filters including at least red colored portions that are colored red, green colored portions that are colored green, and blue colored portions that are colored blue, the red pixels have the red colored portions, the green pixels have the green colored portions, and the blue pixels have the blue colored portions, and the red colored portions and the blue colored portions are thinner than the green colored portions. In this manner, the transmittance of blue and red light through the red colored portions and the blue colored portions, which are relatively thin, is high, which means that the light usage rate can be improved. There is little overlap between the transmission spectra of the red colored portions and the blue colored portions, and thus, the color purity of the blue light and the red light passing through can be maintained at a sufficiently high level, and there is almost no sacrifice of color reproduction.

(10) The magenta light sources each include a red light sources that emits red light and a blue light source that emits blue light. In this manner, compared to a case in which the magenta light sources include a blue light-emitting element that emits blue light and a red phosphor that emits red light by being excited by the blue light emitted from the blue light-emitting element, the color purity for red light and blue light can be made higher. Thus, it is possible to have a higher color reproduction for color images displayed in the display panel.

(11) The green pixels are transparent pixel that allow through all visible light. In this manner, green light from the green light sources illuminated during the green display period passes through the driven transparent pixels, which are the green pixels, to display green in the display panel. Compared to a case in which the green pixels selectively allow through green light, the usage efficiency of green light from the green light sources is improved, which is advantageous from the perspective of reducing power consumption and improving luminance.

(12) The display panel is a liquid crystal panel including a pair of substrates with liquid crystal sealed therebetween. In this manner, the display panel can be used in various applications such as displays for televisions and personal computers, and the display panel is particularly suited as a large display.

### Effects of the Invention

According to the present invention, it is possible to improve color reproduction.

### BRIEF DESCRIPTION OF THE DRAWINGS

FIG. 1 is an exploded perspective view of a schematic configuration of a television receiver according to Embodiment 1 of the present invention.

FIG. 2 is an exploded perspective view of a schematic configuration of a liquid crystal display device provided in the television receiver.

FIG. 3 is a cross-sectional view that shows a cross-sectional configuration of the liquid crystal panel along the longer side direction.

FIG. 4 is a magnified plan view that shows a plan view configuration of an array substrate.

FIG. 5 is a magnified plan view that shows a plan view configuration of a CF substrate.

FIG. 6 is a plan view showing an arrangement configuration of a chassis, light guide plate, and LED substrate in a backlight device provided in the liquid crystal display device.

FIG. 7 is a cross-sectional view of FIG. 6 along the line vii-vii.

FIG. 8 is a cross-sectional view of a magenta LED, a green LED, and an LED substrate.

FIG. 9 is a graph showing transmission spectrums of the color filters included in the liquid crystal panel and the spectrums of light emitted from the magenta LEDs and the green LEDS.

FIG. 10 is a block diagram relating to controlling the liquid crystal panel and the backlight device.

FIG. 11 is a drawing for describing the timing by which the liquid crystal panel and the backlight device are controlled.

FIG. 12 is a drawing showing the CIE1931 chromaticity indicating the NTSC and chromaticity coordinates of Comparison Examples 1 to 3 in Table 1.

FIG. 13 is a drawing showing the CIE1931 chromaticity indicating the chromaticity coordinates of Comparison Example 4 and Working Example 1 in Table 1.

FIG. 14 is a graph showing transmission spectrums of the color filters included in the liquid crystal panel and the spectrums of light emitted from white LEDs of Comparison Example 1.

FIG. 15 is a graph showing transmission spectrums of the color filters included in the liquid crystal panel and the spectrums of light emitted from red LEDs, green LEDs, and blue LEDs of Comparison Examples 2 and 4.

FIG. 16 is a plan view showing an arrangement of a chassis, a light guide plate, and LED substrates in a backlight device according to Embodiment 2 of the present invention.

FIG. 17 is a drawing for describing the timing by which the liquid crystal panel and the backlight device are controlled.

FIG. 18 is a block diagram relating to controlling a liquid crystal panel and a backlight device according to Embodiment 3 of the present invention.

FIG. 19 is a plan view showing an arrangement of a chassis, a light guide plate, and LED substrates in a backlight device according to Embodiment 4 of the present invention.

FIG. 20 is a drawing for describing the timing by which the liquid crystal panel and the backlight device are controlled.

FIG. 21 is a magnified plan view showing a plan view configuration of a CF substrate according to Embodiment 5 of the present invention.

FIG. 22 is a cross-sectional view showing a cross-sectional configuration of a liquid crystal panel of Embodiment 6 of the present invention along the longer side direction.

FIG. 23 is an exploded perspective view schematically showing a liquid crystal display device according to Embodiment 7 of the present invention.

FIG. 24 is a cross-sectional view of the liquid crystal display device.

FIG. 25 is a plan view of an LED substrate.

FIG. 26 is a drawing for describing the timing (red-and-blue display period) by which the liquid crystal panel and the backlight device are controlled.

FIG. 27 is a drawing for describing the timing (green display period) by which the liquid crystal panel and the backlight device are controlled.

FIG. 28 is an exploded perspective view that shows a schematic configuration of a television receiver according to Embodiment 8 of the present invention.

FIG. 29 is a cross-sectional view that shows a cross-sectional configuration of the liquid crystal panel along the longer side direction.

FIG. 30 is a magnified plan view that shows a plan view configuration of an array substrate.

FIG. 31 is a magnified plan view that shows a plan view configuration of a CF substrate.

FIG. 32 is a plan view showing an arrangement of a chassis, a light guide plate, and LED substrates in a backlight device according to Embodiment 9 of the present invention.

FIG. 33 is a plan view of an LED substrate according to Embodiment 10 of the present invention.

### DETAILED DESCRIPTION OF EMBODIMENTS

### Embodiment 1

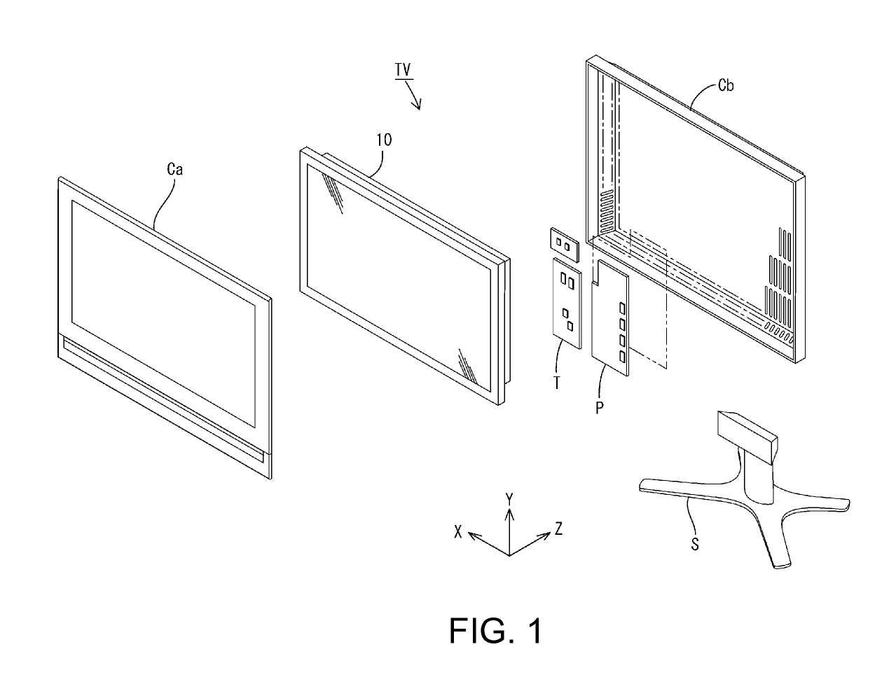

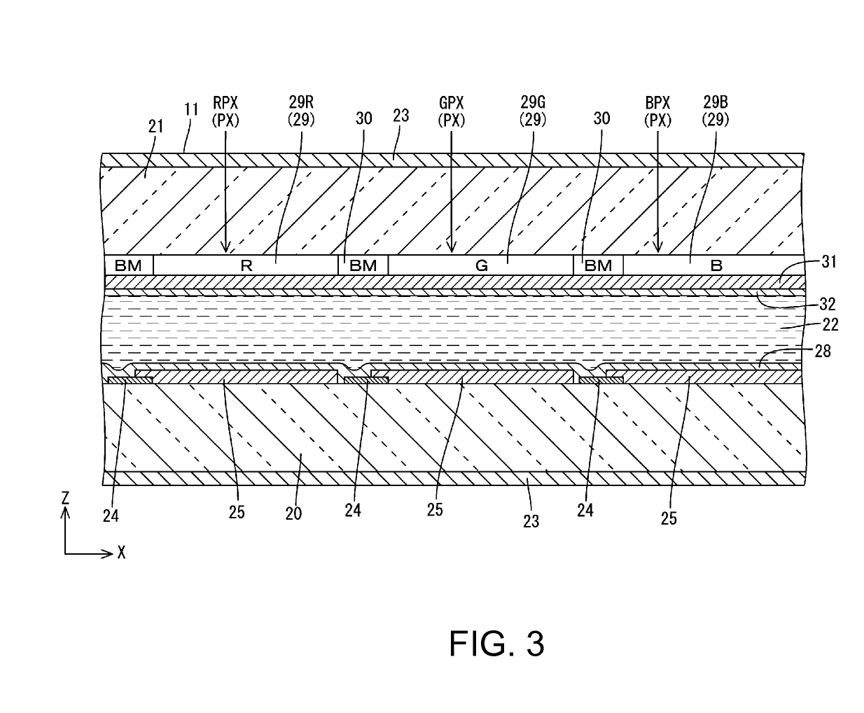

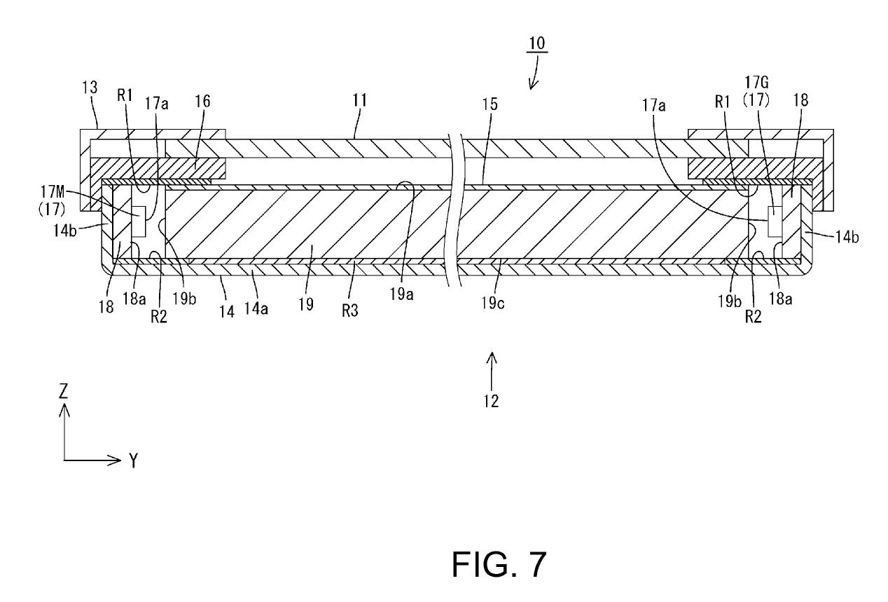

Embodiment 1 of the present invention will be described with reference to FIGS. 1 to 15. In the present embodiment, a liquid crystal display device 10 will be described as an example. The drawings indicate an X axis, a Y axis, and a Z axis in a portion of the drawings, and each of the axes indicates the same direction for the respective drawings. The top side of FIGS. 3 and 7 is the front side, and the bottom side of the same figures is the rear side.

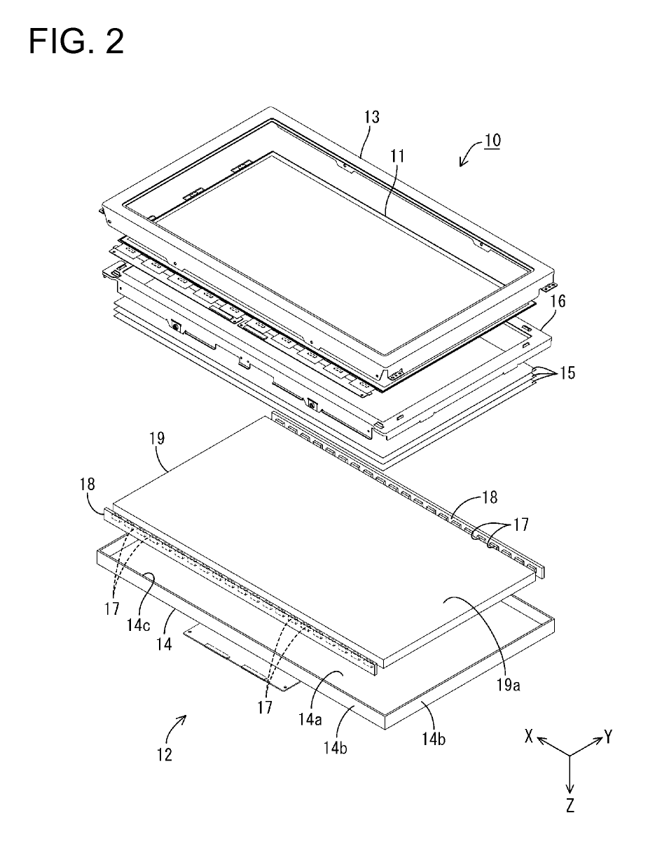

As shown in FIG. 1, a television receiver TV of the present embodiment includes a liquid crystal display device 10, a front cabinet and a rear cabinet Ca and Cb that sandwich the liquid crystal display device 10, a power source P, a tuner T, and a stand S. The liquid crystal display device (display device) 10 is rectangular with a long side being in the horizontal direction, and is stored upright. As shown in FIG. 2, the liquid crystal display device 10 includes a liquid crystal panel 11 that is a display panel, and a backlight device (illumination device) 12 that is an external light source, and these are held together by a frame-shaped bezel 13 or the like.

First, the liquid crystal panel 11 will be described. As shown in FIG. 3, the liquid crystal panel 11 includes a pair of transparent (having light-transmitting properties) glass substrates 20 and 21, and a liquid crystal layer 22, which has a liquid crystal material that changes in optical properties as a result of an applied electric field, sealed therebetween. Of the substrates 20 and 21 that constitute the liquid crystal panel 11, the rear substrate (on the side of the backlight device 12) is an array substrate (TFT substrate, active matrix substrate) 20, and the front substrate (on the side towards which light is emitted) is a CF substrate 21 (opposite substrate). A pair of polarizing plates 23 is bonded on the front and rear of the liquid crystal panel 11, respectively, on the outer surfaces of the substrates 20 and 21.

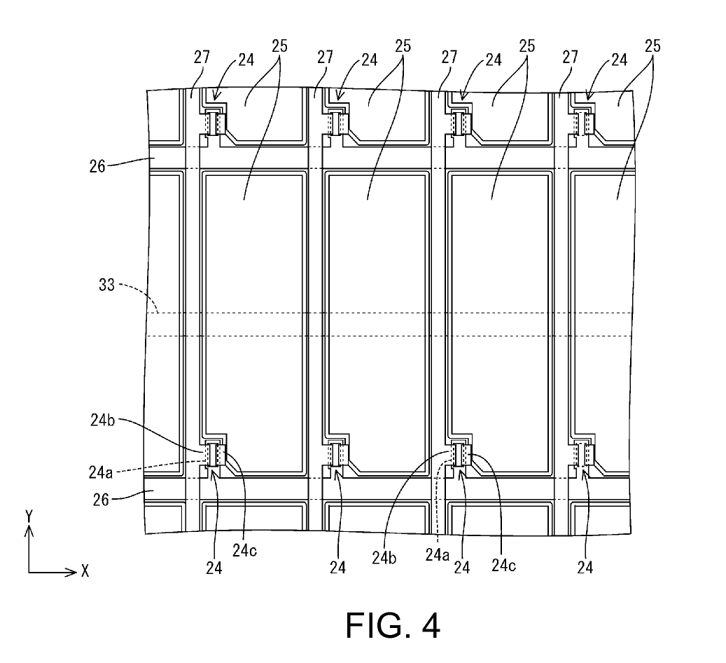

As shown in FIG. 4, on the inner surface of the array substrate 20 (surface facing the liquid crystal layer 22 and opposing the CF substrate 21) a plurality respectively of TFTs 24 (thin film transistors), which are switching elements having three electrodes 24a to 24c, and pixel electrodes 25 are arranged in a matrix, and gate wiring lines 26 and source wiring lines 27 surround the respective TFTs 24 and pixel electrodes 25 to form a grid pattern. The pixel electrodes 25 are made of a transparent conductive film such as ITO (indium tin oxide). The gate wiring lines 26 and the source wiring lines 27 are both made of a conductive material. The gate wiring lines 26 and the source wiring lines 27 are respectively connected to the gate electrodes 24a and the source electrodes 24b of the TFTs 24, and the pixel electrodes 25 are connected to the drain electrodes 24c of the TFT 24 through drain wiring lines (not shown). The array substrate 20 is provided with capacitance wiring lines (auxiliary capacitance wiring lines, storage capacitance wiring lines, Cs wiring lines) that are parallel to the gate wiring lines 26 and overlap the pixel electrodes 25 in a plan view. The capacitance wiring lines 33 are arranged alternately with the gate wiring lines 26 in the Y axis direction. The gate wiring lines 26 are each disposed between pixel electrodes 25 adjacent in the Y axis direction, whereas the capacitance wiring lines 33 are disposed across almost the center of each pixel electrode 25 in the Y axis direction. A terminal portion to which the gate wiring lines 26 and the capacitance wiring lines 33 are drawn and a terminal portion to which the source wiring lines 27 are drawn are provided on the edges of the array substrate 20, and these terminal portions receive various signals or a reference potential from a panel control unit 50 provided on a control substrate that is not shown, and as a result, the driving of the TFTs 24 arranged in a matrix is controlled on an individual basis. Also, an alignment film 28 for orienting liquid crystal molecules included in a liquid crystal layer 22 is formed on the inner surface of the array substrate 20 (FIG. 3).

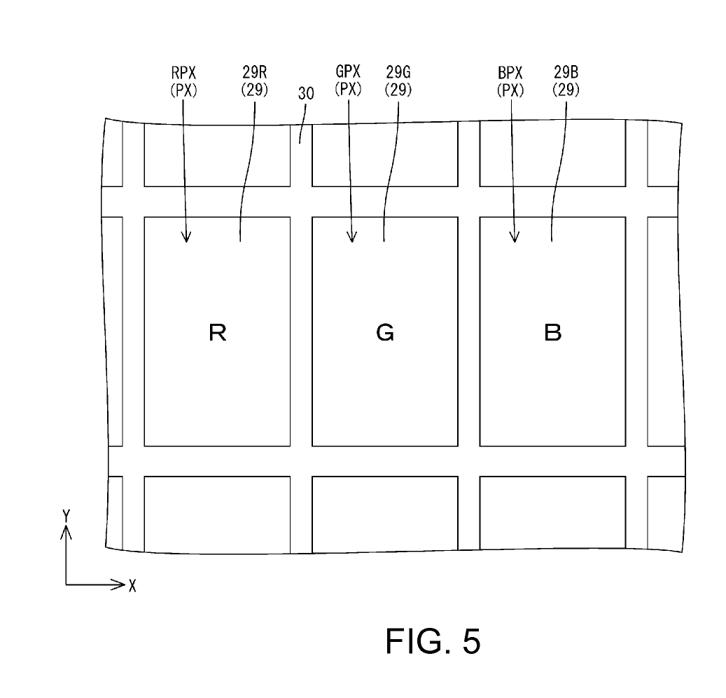

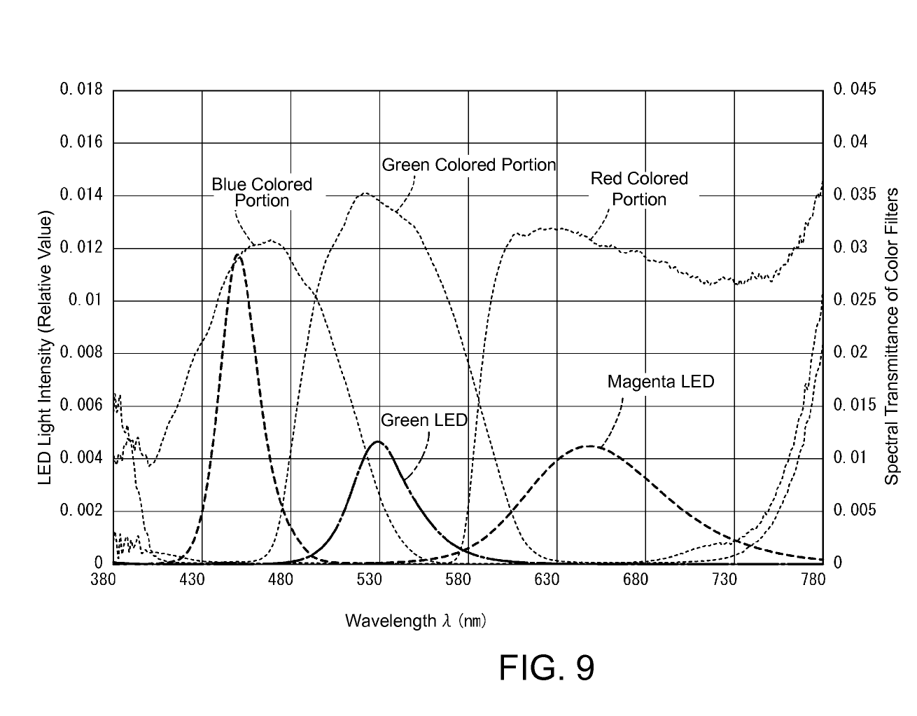

On the other hand, as shown in FIGS. 3 and 5, on the inner surface of the CF substrate 21 (facing liquid crystal layer 22 and opposing the array substrate 20), color filters 29 are arranged in a matrix in positions corresponding respectively to the pixel electrodes 25 on the array substrate 20 in a plan view. The color filters 29 include respective colored portions 29R, 29G, and 29B, which are red, green, and blue, and these colored portions are arranged alternately in the row direction (X axis direction) to formed a colored portion group, and a plurality of these colored portion groups are arranged in the column direction (Y axis direction). The colored portions 29R, 29G, and 29B included among the color filters 29 selectively allow through light of the respective colors (respective wavelengths). Specifically, as shown in FIG. 9, the red colored portion 29R selectively allows through light in the red wavelength region (approximately 600 nm to approximately 780 nm), or in other words, red light. The green colored portion 29G selectively allows through light in the green wavelength region (approximately 500 nm to approximately 570 nm), or in other words, green light. The blue colored portion 29B selectively allows through light in the blue wavelength region (approximately 420 nm to approximately 500 nm), or in other words, blue light. There are two units on the vertical axis of FIG. 9: a “spectral transmittance” as a unit on the right side of the drawing corresponding to the transmittance spectra of the respective colored portions R, G, and B; and a “light intensity (relative value)” as a unit on the left side of the drawing corresponding to the light emission spectra of the LEDs to be described later. As shown in FIG. 5, the outer shapes of the colored portions 29R, 29G, and 29B are vertically long rectangles in a plan view, corresponding to the outer shapes of the pixel electrodes 25. Between the respective colored portions 29R, 29G, and 29B included among the color filters 29, a light-shielding portion 30 (black matrix) forming a grid pattern for preventing color mixing is formed. The light-shielding portion 30 is positioned over the gate wiring lines 26, the source wiring lines 27, and the capacitance wiring lines 33 on the array substrate 20 in a plan view. Also, as shown in FIG. 3, an opposite electrode 31 opposing the pixel electrodes 25 on the array substrate 20 are formed on the surfaces of the color filters 29 and the light-shielding portion 30. Also, on the inner surface of the CF substrate 21, an alignment film 32 for orienting the liquid crystal molecules included in the liquid crystal layer 22 is formed.

In the liquid crystal panel 11, as shown in FIGS. 3 and 5, one unit pixel PX, which is a display unit, is constituted of three colored portions 29R, 29G, and 29B having the colors R, G, and B, and three pixel electrodes 25 facing these colored portions, and a plurality of these unit pixels PX are arranged in a matrix on the surfaces of both substrates 11a and 11b, or in other words, along the display surface (X axis direction and Y axis direction). In other words, the unit pixel PX includes a red pixel RPX having a red colored portion 29R, a green pixel GPX having a green colored portion GPX, and a blue pixel BPX having a blue colored portion 29B. The red pixel RPX, the green pixel GPX, and the blue pixel BPX constituting the unit pixel PX form a group of pixels by being arranged alternately in the row direction (X axis direction), and a plurality of the groups of pixels are arranged in the column direction (Y axis direction). The driving of the TFTs 24 included in the pixels RPX, GPX, and BPX is controlled by the panel control unit 50, thereby causing a prescribed voltage to be applied between the pixel electrodes 25 connected to the respective TFTs 24 and the opposite electrode 31, which then causes the orientation state of the liquid crystal layer 22 interposed therebetween to change in response to the voltage, allowing the amount of light transmitted through the colored portions 29R, 29G, and 29B of the respective colors to be individually controlled.

Next, the backlight device 12 will be explained in detail. As shown in FIG. 2, the backlight device 12 includes a substantially box-shaped chassis 14 having a light-emission portion 14c that is open on the front, or in other words, the light-emission side (liquid crystal panel 11 side), optical members 15 disposed to cover the light-emission portion 14c of the chassis 14, and a frame 16 that presses a light guide plate 19 to be described next from the front. Inside the chassis 14, LED substrates 18 (light source substrates) on which LEDs 17 (light emitting diodes), which are light sources, are mounted, and a light guide plate 19 that guides light from the LEDs 17 towards the optical members 15 (towards the liquid crystal panel 11, direction in which light is emitted) are housed. A pair of LED substrates 18 having LEDs 17 are arranged on both longer sides of the backlight device 12, and the pair of LED substrates 17 sandwich the light guide plate 19 from both sides in the shorter side direction (Y axis direction). The LEDs 17 mounted on the LED substrates 18 are disposed on the longer side edges of the liquid crystal panel 11; a plurality of LEDs 17 arranged along the edges, or in other words, the longer side direction (X axis direction). Thus, the backlight device 12 of the present embodiment is of a so-called edge lit (side lit) type. Each component of the backlight device 12 will be described in detail below.

The chassis 14 is made of a metal plate such as an aluminum plate or an electro galvanized steel sheet (SECC), and as shown in FIGS. 2, 6, and 7, includes a bottom plate 14a having a horizontally long rectangular shape similar to the liquid crystal panel 11, and side plates 14b that rise from the outer edge sides (pair of long sides and pair of short sides) of the bottom plate 14a towards the front. In the chassis 14 (bottom plate 14a), the long side direction thereof matches the X axis direction, and the short side direction thereof matches the Y axis direction. Substrates such as a control substrate and an LED driver circuit substrate, which are not shown, are attached to the rear of the bottom plate 14a. The frame 16 and the bezel 13 can be fixed onto the sides 14b with screws.

As shown in FIG. 2, the optical members 15 are in a horizontally long rectangular shape in a plan view, as in the liquid crystal panel 11 and the chassis 14. The optical members 15 are disposed on the front side (light-emission side) of the light guide plate 19, between the liquid crystal panel 11 and the light guide plate 19, thus allowing through light emitted from the light guide plate 19 and applying prescribed optical effects on the transmitted light, and emitting light towards the liquid crystal panel 11. The optical members 15 include of a plurality (three in the present embodiment) of sheet-shaped members that are stacked one on top of the other. Specific types of optical members 15 (optical sheets) include a diffusion sheet, a lens sheet, a reflective polarizing sheet, and the like, for example, and it is possible to appropriately choose any of these as optical members 15. In FIG. 7, the three optical members 15 are shown as one optical member for ease of depiction.

As shown in FIG. 2, the frame 16 is formed in a frame shape that extends along the outer edges of the light guide plate 19, and can press almost the entire outer edge of the light guide plate 19 from the front side. The frame 16 is made of a synthetic resin, and by having the surface thereof colored black, for example, the frame 16 has light-shielding properties. The rear surface of the long sides of the frame 16, or in other words, the portions facing the light guide plate 19 and the LED substrates 18 (LEDs 17) are respectively provided with first reflective sheets R1 that reflect light, as shown in FIG. 3. The first reflective sheets R1 have a size sufficient to extend along almost the entire length of the long sides of the frame 16, the first reflective sheets R1 directly abutting edges of the light guide plate 19 opposite to the LEDs 17 and covering the edges of the light guide plate 19 and the LED substrates 18. The frame 16 can receive the outer edges of the liquid crystal panel 11 from the rear side.

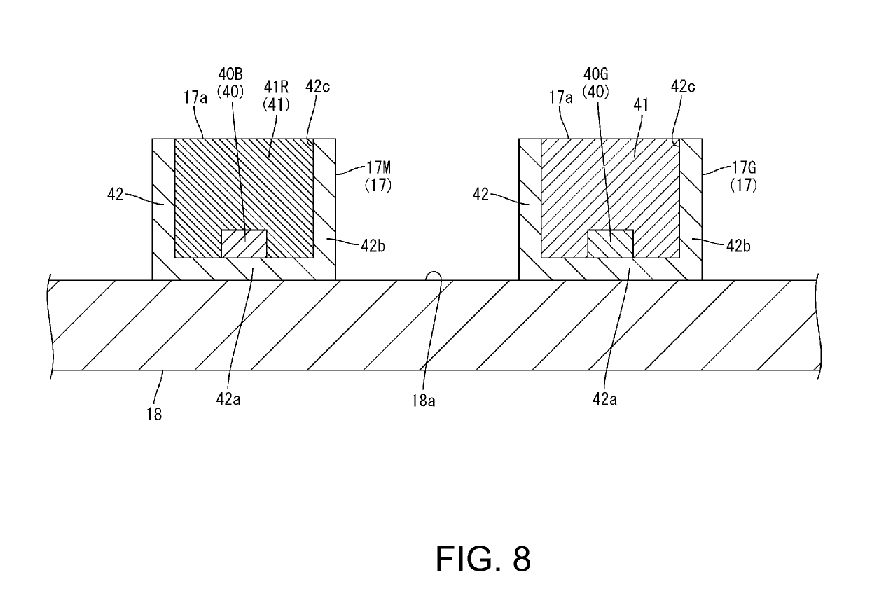

As shown in FIGS. 2 and 7, the LEDs 17 are mounted on the surfaces of the LED substrates 18, and the light-emitting surfaces 17a of the LEDs 17 face a direction opposite to the LED substrates 18, thereby being of a so-called top-emitting type. Specifically, as shown in FIG. 8, the LEDs 17 each include an LED element 40 (LED chip, light-emitting element) that is a light source, a sealing material 41 (transparent resin material) that seals the LED element 40, and a case (housing member) in which the LED element 40 is housed and into which the sealing material 41 is filled. The components of the LEDs 17 will be respectively described in detail with reference to FIG. 8.

The LED element 40 is a semiconductor made of a semiconductor material such as InGaN, for example, and by applying a forward voltage thereto, the LED element 40 can emit visible light in a prescribed wavelength range. The LED element 40 is connected by a lead frame, which is not shown, to a wiring pattern on the LED substrate 18 disposed outside of the case 42. The sealing material 41 is made of an almost transparent thermosetting resin material, and is specifically made of an epoxy resin or a silicon resin. The sealing material 41 fills the internal space of the case 42 housing the LED element 40 during the manufacturing process of the LEDs 17, and thus, the LED element 40 and the lead frame are sealed, thereby protecting them.

The case 42 is made of a synthetic resin (such as a polyamide resin) or a ceramic material having a surface with a white color having excellent light reflectance. The case 42 overall has a substantially box shape having an opening 42c on the light-emission side (towards the light-emitting surface 17a, opposite to the LED substrate 18), and generally includes a bottom plate 42a that extends along the mounting surface of the LED substrate 18 and side walls 42b that rise from the outer edges of the bottom plate 42a. Of these, the bottom plate 42a has a rectangular shape when viewed in the light-emission direction, and the side walls 42b form a substantially square tube shape along the outer edges of the bottom plate 42a, the side walls 42b having a rectangular frame shape when viewed in the light-emission direction. The LED element 40 is disposed on the inner surface (bottom surface) of the bottom plate 42a of the case 42. The lead frame penetrates the side walls 42b. The end of the lead frame inside the case 42 is connected to the LED element 40, whereas the end of the lead frame guided outside the case 42 is connected to the wiring pattern on the LED substrate 18.

As shown in FIGS. 2, 6, and 7, the LED substrate 18 on which the plurality of LEDs 17 are mounted has a long plate shape extending along the longer side direction of the chassis 14 (edges of liquid crystal panel 11 and light guide plate 19 facing the LEDs 17, X axis direction), and the LED substrate 18 is housed in the chassis 14 such that the surface thereof is parallel to the plane along the X axis direction and the Z axis direction, or in other words, perpendicular to the surfaces of the liquid crystal panel 11 and the light guide plate 19 (optical members 15). In other words, the LED substrates 18 are disposed such that the longer side direction of the surface thereof is the same as the X axis direction, the shorter side direction of the surface thereof is the same as the Z axis direction, and the substrate thickness direction perpendicular to the surface is the same as the Y axis direction. The LED substrates 18 are disposed with the light guide plate 19 therebetween in the Y axis direction, and specifically, the LED substrates 18 are disposed between the light guide plate 19 and the respective side plates 14b on the longer sides of the chassis 14, the LED substrates 18 being housed in the chassis 14 from the front in the Z axis direction. The surfaces of the LED substrates 18 opposite to the mounting surfaces 18a where the LEDs 17 are mounted are respectively attached to the inner surfaces of the respective side plates 14b on the longer sides of the chassis 14. Therefore, the light-emitting surfaces 17a of the LEDs 17 respectively disposed on the LED substrates 18 face each other, and the optical axes of the respective LEDs 17 substantially match the Y axis direction (direction parallel to the surface of the liquid crystal panel 11).

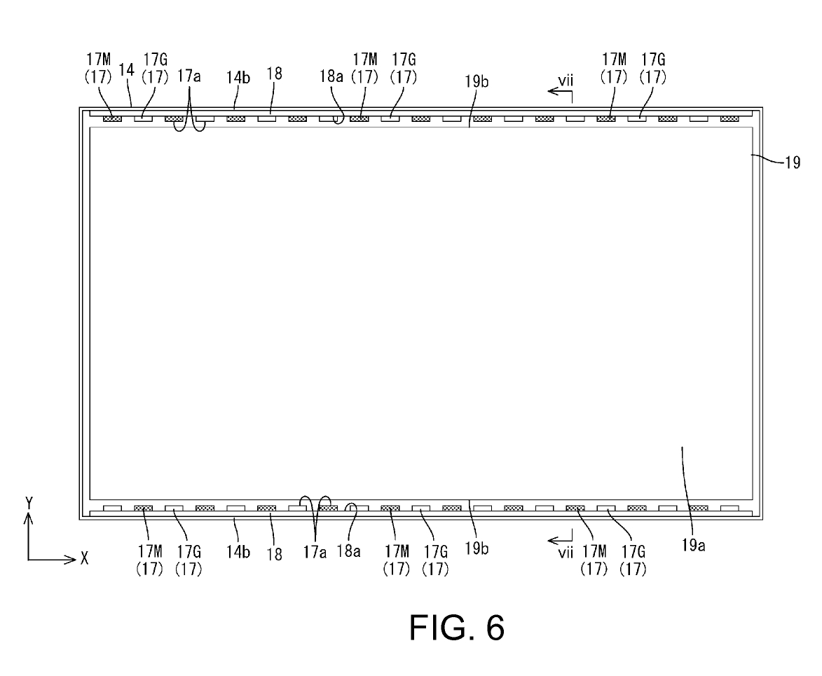

As shown in FIGS. 2, 6, and 7, the surface of the LED substrate 18 facing the inner side, or in other words, the light guide plate 19 (surface opposing the light guide plate 19) is provided with the plurality (19 in FIG. 6) of LEDs 17, which are arranged along the longer side direction of the LED substrates 19 (longer side direction of the liquid crystal panel 11 and the light guide plate 19, X axis direction) at a gap from each other. Each LED 17 is mounted on the surface of the LED substrate 18 facing the light guide plate 19, and this is designated as a mounting surface 18a. The mounting surface 18a of the LED substrate 18 has formed thereon a wiring pattern (not shown) made of a metal film (copper foil or the like), which is disposed across the group of LEDs while extending in the X axis direction so as to connect adjacent LEDs 17 in series, and a terminal portion where the end of this wiring pattern is formed is electrically connected to a backlight control unit 51 provided on an LED driver circuit substrate (not shown) through a wiring member or the like, thus causing driving power from the backlight control unit 51 to be supplied to the respective LEDs 17. The LED substrates 18 are of a single surface mounting type, in which only one of the surfaces thereof is the mounting surface 18a. The intervals between respective adjacent LEDs 17 along the X axis direction are substantially equal to each other, or in other words, the LEDs 17 are arranged at substantially the same pitch. The base material of the LED substrate 18 is made of a metal such as aluminum, for example, and the above-described wiring pattern (not shown) is formed on the surface across an insulating layer. The base material used in the LED substrate 18 can be an insulating material such as a synthetic resin or a ceramic.

The light guide plate 19 is made of a synthetic resin (such as an acrylic, for example) that is almost completely transparent (excellent light transmittance) and has a refractive index that is sufficiently higher than air. As shown in FIGS. 2 and 6, the light guide plate 19 is a rectangular flat plate that is horizontally long in a plan view, in a manner similar to the liquid crystal panel 11 and the bottom plate 14a of the chassis 14, and the surface of the light guide plate 19 faces the respective surfaces of the liquid crystal panel 11 and the optical members 15 while facing these. The longer side direction of the surface of the light guide plate 19 matches the X axis direction and the shorter side direction thereof matches the Y axis direction, while the thickness direction perpendicular to the surface of the light guide plate 19 matches the Z axis direction. As shown in FIG. 7, the light guide plate 19 is disposed in the chassis 14 and directly below the liquid crystal panel 11 and the optical members 15, and the pair of longer side edge faces among the outer edge faces of the light guide plate 19 face the LEDs 17 on the pair of LED substrates 18 disposed on longer sides of the chassis 14. Thus, while the LEDs 17 (LED substrates 18) and the light guide plate 19 are aligned in the Y axis direction, the optical members 15 (liquid crystal panel 11) and the light guide plate 19 are aligned in the Z axis direction, and the alignment directions thereof are perpendicular to each other. The light guide plate 19 has the function of guiding light emitted in the Y axis direction from the LEDs 17 from the longer side edge faces, propagating the light therein, and emitting the light from the surfaces thereof so as to travel upward towards the optical members 15 (towards the front; light-emission direction). The light guide plate 19 is disposed in a central position of the bottom plate 14a of the chassis 14 in the shorter side direction, and thus, is supported from the rear at the central portion of the bottom plate 14a in the shorter side direction. The light guide plate 19 is formed to be slightly larger than the optical members 15, and the outer edge portions thereof protrude farther outward than the outer edge faces of the optical members 15 while being pressed by the above-mentioned frame 16 (FIG. 7).

Of the surfaces of the plate shaped light guide plate 19, the front surface (facing the liquid crystal panel 11 and the optical members 15) is a light-emitting surface 19a that emits the light inside the light guide plate 19 towards the optical members 15 and the liquid crystal panel 11, as shown in FIGS. 6 and 7. Of the outer edge faces adjacent to the surface of the light guide plate 19, the pair of longer edge faces having an elongated shape along the X axis direction (direction in which the LEDs 17 are arranged, longer side direction of the LED substrates 18) face the LEDs 17 (LED substrates 18) at a prescribed gap therefrom, and these edge faces are light-receiving faces 19b into which light from the LEDs 17 enters. Towards the front of the space between the LEDs 17 and the light-receiving face 19b, the above-mentioned first reflective sheet R1 is disposed, whereas towards the rear of the same space, a second reflective sheet R2 is disposed, such that the first reflective sheet R1 and the second reflective sheet R2 are on either side of the space. The reflective sheets R1 and R2 sandwich the edges of the light guide plate 19 towards the LEDs 17 and the LEDs 17 in addition to the space. As a result, light from the LEDs 17 is repeatedly reflected by the reflective sheets R1 and R2, and thus, the light can efficiently enter the light-receiving faces 19b. The light-receiving surfaces 19b are on a plane parallel to that defined by the X axis and the Z axis, and are substantially perpendicular to the light output surface 19a. The direction along which the LEDs 17 and the light-receiving faces 19b are aligned with respect to each other is the same as the Y axis direction, and is parallel to the light-emitting surface 19a.

Of the surfaces of the light guide plate 19, a surface 19c opposite to the light-emitting surface 19a is provided with a third reflective sheet R3 covering the entire surface 19c, the third reflective sheet R3 being able to reflect light in the light guide plate 19 towards the front. In other words, the third reflective sheet R3 is interposed between the bottom plate 14a of the chassis 14 and the light guide plate 19. At least one of the surface 19c opposite to the light-emitting surface 19a of the light guide plate 19 and the surface of the third reflective sheet R3 is given a pattern such that a light scattering portion (not shown) that scatters light in the light guide plate 19 has a prescribed surface distribution, and as a result, light emitted from the light-emitting surface 19a can be controlled to have an even distribution across the surface.

As shown in FIG. 8, magenta LEDs 17M that emit magenta light and green LEDs 17G that emit green light are included among the plurality of LEDs 17 mounted on the LED substrates 18 of the present embodiment. The LED 17 shown on the left of FIG. 8 is the magenta LED 17M, and the LED 17 on the right of the same page is the green LED 17G. The configurations of the magenta LEDs 17M and the green LEDs 17G will be described. When distinguishing the types of LEDs 17 below, “M” is added to the reference character for the magenta LEDs and “G” is added to the reference character for green LEDs, and if no distinction needs to be made, no letter is added.

As shown in FIG. 8, the magenta LED 17M has a blue LED element 40B (blue light-emitting element) that emits blue light as the LED element 40, and has, as the sealing material 41, a red phosphor-containing sealing material 41R including a red phosphor (not shown) that emits red light by being excited by the blue light from the blue LED element 40B. Therefore, the magenta LED 17M can emit a magenta light overall by mixing the blue light (blue component light) emitted from the blue LED element 40B and the red light (red component light) emitted by the red phosphor excited by the blue light from the blue LED element 40B. On the other hand, the green LED 17G has a green LED element 40G (green light-emitting element) that emits green light as the LED element 40, and a sealing material 41 made of a transparent resin that does not contain a phosphor. Thus, the green light emitted by the green LED element 40G is emitted as is by the green LED 17G. When distinguishing the s 40 and the sealing materials 41, “B” is added to the reference character for the blue LED element, “G” is added to the reference character for the green LED element, and R is added to the reference character for the red phosphor-containing sealing material, and no letters are added when no distinction is made.

As shown in FIGS. 8 and 9, the blue LED element 40B in the magenta LED 17M is made of a semiconductor material such as InGaN, for example, has a primary wavelength for emitted light in the blue wavelength region (approximately 420 nm to approximately 500 nm), and emits only blue. Therefore, the light emitted by the blue LED element 40B is used as a portion of the light emitted by the magenta LED 17M (magenta light), and is also used as the excitation light from the red phosphor to be described next. The red phosphor-containing sealing material 41R in the magenta LED 17M has a red phosphor dispersed in a transparent resin material, and functions as a binder containing the red phosphor. The red phosphor is excited by the light from the blue LED element 40B and emits, as its primary wavelength, light in the red wavelength region (approximately 600 nm to approximately 780 nm). Specifically, it is preferable to use CASN, which is a type of CASN type phosphor, as the red phosphor. The CASN type phosphor is a nitride that includes calcium atoms (Ca), aluminum atoms (Al), silicon atoms (Si), and nitrogen atoms (N), and has superior light-emitting efficiency and durability compared to other phosphors made of a sulfide or oxide, for example. In the CASN type phosphor, a rare earth element (such as Tb, Yg, or Ag) is used as an activator. CASN, which is a type of the CASN type phosphor, includes Eu (europium) as an activator, and is represented by a compositional formula of CaAlSiN3:Eu CaAlSiN3:Eu. CASN, which is the red phosphor of the present embodiment, emits light at a primary wavelength of approximately 650 nm, for example.

As shown in FIGS. 8 and 9, the green LED element 40G in the green LED 17G is made of a semiconductor material such as InGaN, for example, and emits light at a primary wavelength in the green wavelength region (approximately 500 nm to approximately 570 nm), and emits only green light. The green LED element 40G has a different primary wavelength from the blue LED element 40B in the above-mentioned magenta LED 17M, but is made of the same semiconductor material (InGaN). As a result, it is possible to use a similar drive voltage to drive the green LED 17G and the magenta LED 17M, allowing for a common power source in the backlight control unit 51. Furthermore, the green LED element 40G and the blue LED element 40B undergo a similar change in chromaticity (wavelength) in emitted light under certain temperature characteristics, or in other words, when the temperature changes, making color unevenness in the emitted light unlikely.

As shown in FIG. 6, the magenta LED 17 and the green LED 17G having the configuration above are aligned alternately on the mounting surface 18a of the LED substrate 18 in the length direction (X axis direction) thereof. In FIG. 6, the magenta LED 17M is shown with shading. The wiring patterns formed on the LED substrate 18 include magenta wiring patterns for connecting the plurality of magenta LEDs 17M together in series, and green wiring patterns (neither these nor the magenta wiring patterns are shown) for connecting the plurality of green LEDs 17G together in series. As a result, the plurality of magenta LEDs 17M and the plurality of green LEDs 17G mounted on the same LED substrate 18 are controlled independently in terms of luminance and the timing by which they are ON or OFF. Also, the magenta LEDs 17M and the green LEDs 17G mounted on one of the pair of LEDs 18 surrounding the light guide plate 19, and the magenta LEDs 17M and the green LEDs 17G mounted on the other LED substrate 18 are disposed such that the same color LEDs on the opposing LED substrates 18 do not face each other. In other words, the magenta LEDs 17 mounted on one LED substrate 18 are in the same position in the X axis direction as the green LEDs 17 mounted on the other LED substrate 18 (so as to face each other in the Y axis direction across the light guide plate 19), and the green LEDs 17G mounted on one LED substrate 18 are in the same position in the X axis direction as the magenta LEDs 17M mounted on the other LED substrate 18.

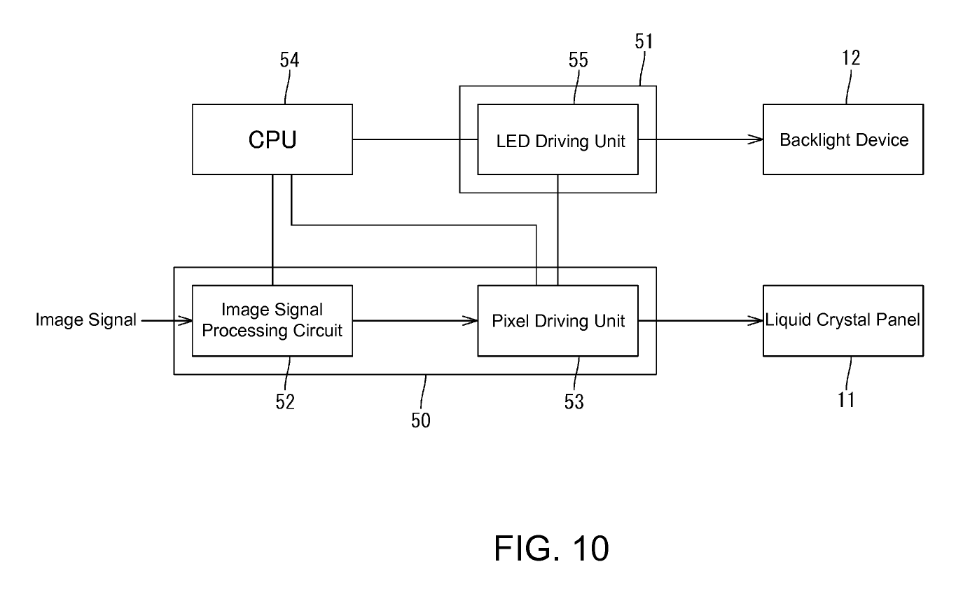

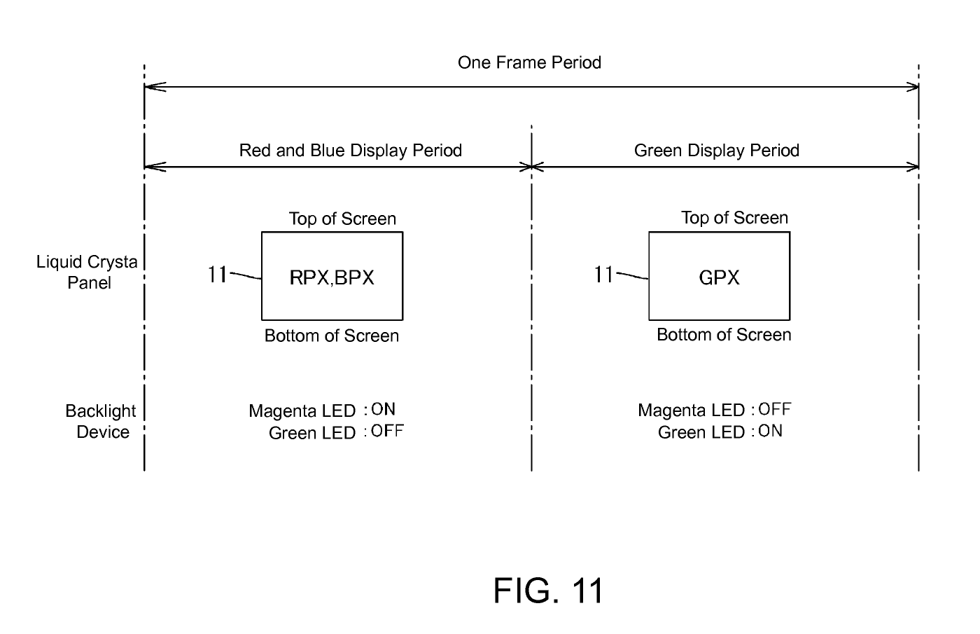

The liquid crystal display device 10, which includes a liquid crystal panel 11 having red pixels RPX, green pixels GPX, and blue pixels BPX, and a backlight device 12 having two types of LEDs 17G and 17M emitting different colors, has the following configuration. As shown in FIGS. 10 and 11, the liquid crystal display device 10 includes: a panel control unit 50 that controls the liquid crystal panel 11 so as to include, during each frame period, a red-and-blue display period during which red and blue pixels RPX and BPX are selectively driven so as to display red and blue, and a green display period during which green pixels GPX are selectively driven to emit green light; and a backlight control unit 51 (illumination control unit) that controls the backlight device 12 such that during the red-and-blue display period, magenta LEDs 17M are turned ON and green LEDs 17G are turned OFF, whereas during the green display period, the green LEDs 17G are turned ON and the magenta LEDs 17M are turned OFF. In FIG. 11, the driven pixels are indicated with the reference characters RPX, GPX, and BPX under the “liquid crystal panel” row, and under the “backlight device” row, “ON” indicates that the magenta LEDs and the green LEDs are turned ON, and “OFF” indicates that these LEDs are OFF.

As shown in FIG. 10, the panel control unit 50 has an image signal processing circuit 52 that processes image signals, and a pixel driving unit 53 that drives the red pixels RPX, the green pixels GPX, and the blue pixels BPX on the basis of signals outputted from the image signal processing circuit 52, and the panel control unit 50 is provided on the control substrate. The control substrate is provided with a CPU 54 that respectively controls the operations of the image signal processing circuit 52, the pixel driving unit 53, and the LED driving unit 55 to be described later. If the frame rate of the outputted signal processed by the image signal processing circuit 52 is approximately 60 fps, for example, then each frame period is approximately 1/60 s (approximately 16.67 ms). In the present embodiment, the liquid crystal panel 11 is controlled by the panel control unit 50 such that a red-and-blue display period and a green display period are included in each frame period. Therefore, the pixel driving unit 53 drives the pixels RPX, GPX, and BPX such that the red-and-blue display period and the green display period are each approximately 1/120 s (approximately 8.33 ms). The pixel driving unit 53 sequentially scans along the column direction a group of pixels including a plurality each of the red pixels RPX, green pixels GPX, and blue pixels BPX arranged so as to repeat in the row direction. Specifically, as shown in FIG. 11, the scanning of the pixels RPX, GPX, and BPX by the pixel driving unit 53 starts from a group of pixels at the top end of the liquid crystal panel 11, and sequentially scans the pixels until it reaches the group of pixels at the bottom end of the liquid crystal panel 11. During the red-and-blue display period, the pixel driving unit 53 selectively drives only the red pixels RPX and the blue pixels BPX among the group of pixels, while it selectively drives only the green pixels GPX among the group of pixels during the green display period. Thus, in the liquid crystal panel 11, red and blue display and green display are performed alternately in each frame period.

Meanwhile, as shown in FIG. 10, the backlight control unit 51 has an LED driving unit 55 that drives magenta LEDs 17M and green LEDs 17G on the basis of signals outputted from the image signal processing circuit 52, and is provided on the LED driver circuit substrate. Operations of the LED driving unit 55 are controlled by the CPU 54 on the control substrate, so as to be in synchronization with the operation of the pixel driving unit 53. Specifically, as shown in FIG. 11, the LED driving unit 55 turns ON the magenta LEDs 17M and turns OFF the green LEDs 17G during the red-and-blue display period included in each frame period when the pixel driving unit 53 drives the pixels RPX, GPX, and BPX of the liquid crystal panel 11, whereas during the green display period, the green LEDs 17G are turned ON and the magenta LEDs 17M are turned OFF. In this manner, during the red-and-blue display period, the magenta light emitted from the magenta LEDs 17M passes through the red pixels RPX and the blue pixels BPX selectively driven in the liquid crystal panel 11, thereby attaining blue transmitted light and red transmitted light for red and blue display. At this time, the green LEDs 17G are turned OFF, and thus, green light, which is not displayed at this time, is prevented from be radiated on the red pixels RPX and the blue pixels BPX, thereby allowing a high color purity for light transmitted through the red pixels RPX and the blue pixels BPX. As shown in FIG. 9, the transmission spectra of the red colored portions 29R and the blue colored portions 29B respectively of the red pixels RPX and the blue pixels BPX have almost no overlap. Therefore, by allowing magenta light from the magenta LEDs 17M through the red pixels RPX and the blue pixels BPX, it is possible to extract red light and blue light having a high color purity. Even compared to a conventional case in which cyan colored portions and yellow colored portions are used, because only red light selectively passes through the red pixels RPX and only blue light selectively passes through the blue pixels BPX and almost no light of other colors such as green passes therethrough, the color purity of the transmitted light can be made higher.

Meanwhile, as shown in FIG. 11, during the green display period, green light emitted by the green LEDs 17G passes through the green pixels GPX selectively driven in the liquid crystal panel 11, resulting in green transmitted light and green display. At this time, the magenta LEDs 17M are turned OFF, and thus, red light and blue light, which are not displayed at this time, are prevented from passing through the driven green pixels GPX, and therefore, high color purity can be attained for light transmitted through the green pixels GPX. In particular, as shown in FIG. 9, the green colored portions 29G have a transmission spectrum overlapping those of the red colored portions 29R and the blue colored portions 29B, and thus, if magenta light were to be radiated, then portions of the magenta light close to the wavelength region of green light (approximately 480 nm, approximately 580 nm) passes through the green pixels GPX, which has the possibility of markedly worsening the color purity of light transmitted through the green colored portions 29G. Thus, by having the green pixels GPX driven at a different time from the red pixels RPX and the blue pixels BPX driven when the magenta LEDs 17M are ON, magenta light is prevented from being radiated on the green pixels GPX, which allows for high purity of light transmitted therethrough.

<Comparison Experiment 1>

Next, Comparison Experiment 1 will be described. In Comparison Experiment 1, the above-mentioned liquid crystal display device 10 is designated as Working Example 1, and liquid crystal display devices in which the configuration of light sources or the controls of the liquid crystal panel and backlight device are modified are designated as Comparison Examples 1 to 4, and the chromaticities of display images in Working Example 1 and Comparison Examples 1 to 4 are respectively measured. The configuration of the liquid crystal panels of Comparison Examples 1 to 4 is similar to that of Working Example 1, but the configuration of the light sources of the backlight devices and the controls for the liquid crystal panels and backlight device differ from that of Working Example 1, and will be described in detail below.

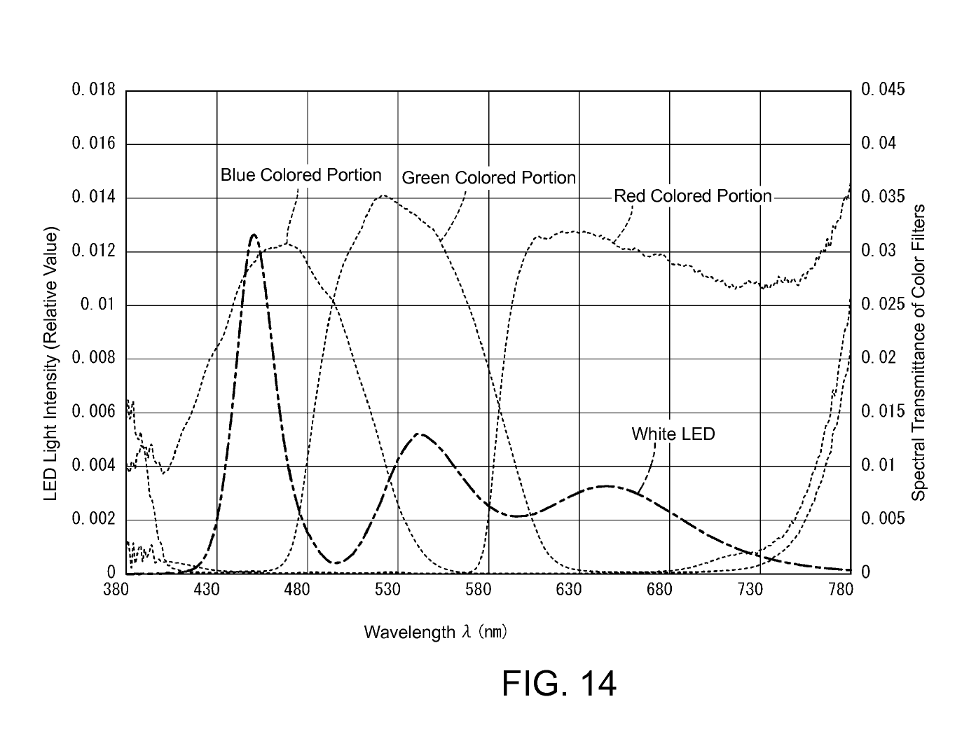

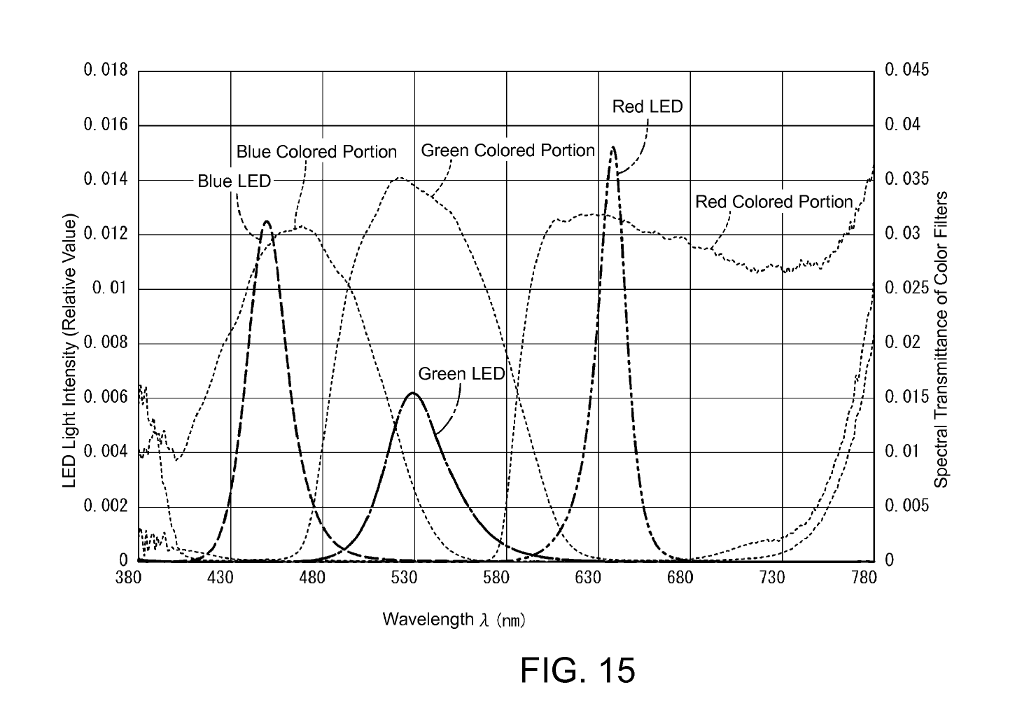

In Comparison Example 1, only white LEDs that emit white light are included as light sources in the backlight device, and images are displayed in the liquid crystal panel by illuminating the white LEDs while driving the red pixels, green pixels, and blue pixels in the liquid crystal panel simultaneously during each frame period. The white LEDs of Comparison Example 1 include a blue LED element that emits blue light, as well as a red phosphor that emits red light by being excited by the blue light from the blue LED element and a green phosphor that emits green light by being excited by the blue light from the blue LED element. The emission spectrum of the white LEDs is as shown in FIG. 14. The horizontal and vertical axes of FIG. 14 are similar to those of FIG. 9. In Comparison Example 2, three types of LEDs including red LEDs that emit red light, green LEDs that emit green light, and blue LEDs that emit blue light are used as the light sources of the backlight device, and images are displayed in the liquid crystal panel by turning on all three types of LEDs simultaneously while driving the red pixels, the green pixels, and the blue pixels in the liquid crystal panel simultaneously during each frame period. In Comparison Example 2, the red LEDs have red LED elements that emit red light, the green LEDs have green LED elements that emit green light, and the blue LEDs have blue LED elements that emit blue light. The red LEDs, green LEDs, and blue LEDs do not have phosphors in the sealing material made of a transparent resin, and light emitted from the respective LED elements is emitted as is from the LEDs. The emission spectra of the red LEDs, green LEDs, and blue LEDs are as shown in FIG. 15. The horizontal and vertical axes of FIG. 15 are similar to those of FIGS. 9 and 14. In Comparison Example 3, two types of LEDs including magenta LEDs that emit magenta light, and green LEDs that emit green light are used as the light sources of the backlight device, and images are displayed in the liquid crystal panel by turning on both types of LEDs simultaneously while driving the red pixels, the green pixels, and the blue pixels in the liquid crystal panel simultaneously during each frame period. The magenta LEDs and the green LEDs of Comparison Example 3 are the same as the ones described next in Working Example 1.

In Comparison Example 4, three types of LEDs including red LEDs that emit red light, green LEDs that emits green light, and blue LEDs that emit blue light are used as the light sources of the backlight device. Images are displayed in the liquid crystal panel by including, during each frame period, a red display period during which red pixels of the liquid crystal panel are selectively driven to perform red display, a green display period during which green pixels are selectively driven to perform green display, and a blue display period during which blue pixels are selectively driven to perform blue display. During the red display period, only red LEDs are illuminated, during the green display period, only green LEDs are illuminated, and during the blue display period, only blue LEDs are driven. The red LEDs, the green LEDs, and the blue LEDs of Comparison Example 4 are the same as those of Comparison Example 2. In Working Example 1, two types of LEDs including the magenta LEDs 17M emitting magenta light and green LEDs 17G emitting green light are used as the light sources of the backlight device 12. Images are displayed in the liquid crystal panel 11 by including, during each frame period, a red-and-blue display period during which red pixels RPX and blue pixels BPX of the liquid crystal panel 11 are selectively driven to display red and blue, and a green display period during which green pixels GPX are selectively driven to display green. During the red-and-blue display period, only the magenta LEDs 17M are illuminated, and during the green display period, only green LEDs 17G are illuminated.

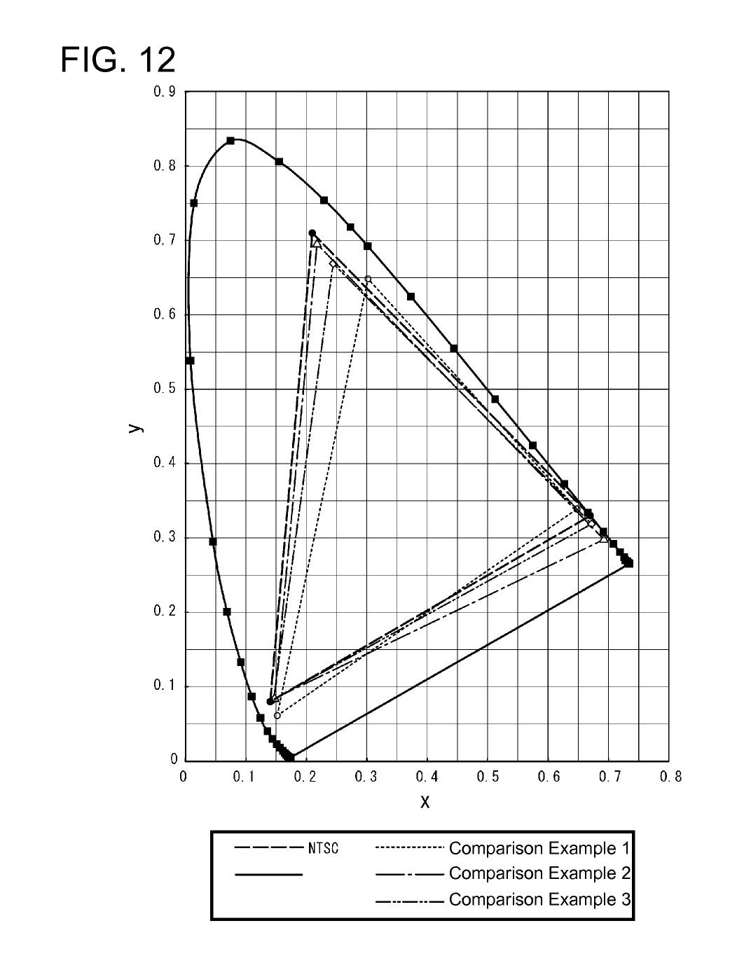

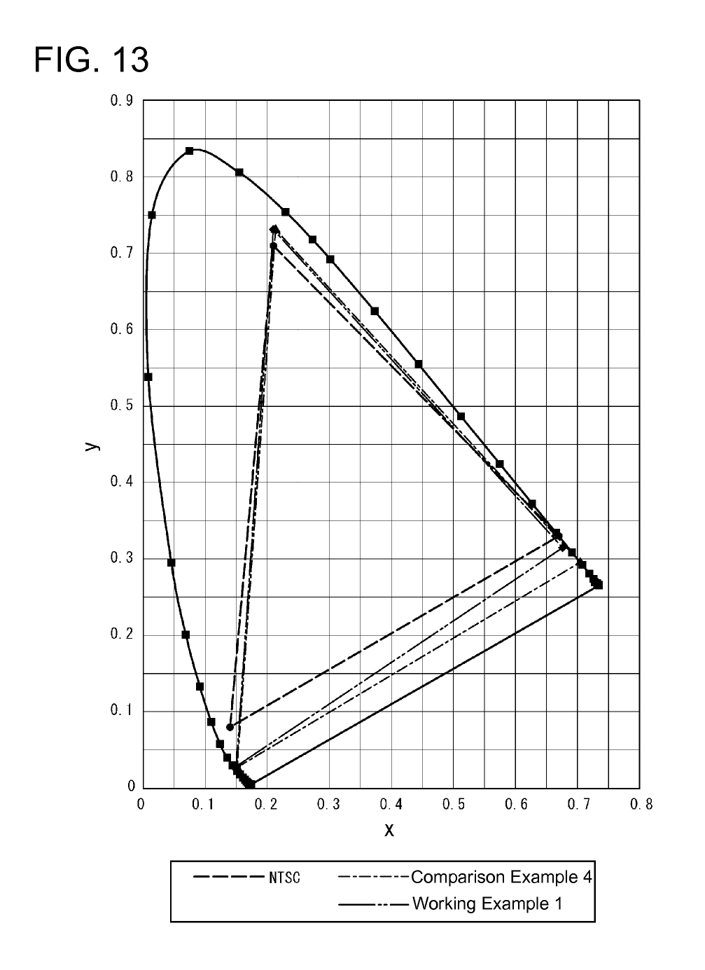

In Comparison Examples 1 to 4 and Working Example 1, a pure red image, a pure green image, and a pure blue image are respectively displayed, and the chromaticity of the displayed images measured by spectrophotometry, for example, are shown in Table 1 below and FIGS. 12 and 13. In Table 1, “R” indicates the display of a red-only image, “G” indicates the display of a green-only image, and “B” indicates the display of a blue-only image. The x and y values of “R,” “G,” and “B” are chromaticity coordinate values on CIE (Commission Internationale de l′Eclairage) 1931 chromaticity diagrams shown in FIGS. 12 and 13. FIGS. 12 and 13 are both CIE 1931 chromaticity diagrams; FIG. 12 shows chromaticity areas for NTSC and Comparison Examples 1 to 3, and FIG. 13 shows chromaticity areas for Comparison Example 4 and Working Example 1. In FIGS. 12 and 13, the chromaticity areas of Comparison Examples 1 to 4 and Working Example 1 are indicated as triangular regions having three vertices at the primary colors of R, G, and B shown in Table 1. “NTSC” in Table 1 is the chromaticity according to NTSC (National Television System Committee) standards, and the triangular regions with the bold broken lines in FIGS. 12 and 13 are the NTSC chromaticity area according to NTSC standards. In FIG. 12, the chromaticity area of Comparison Example 1 is shown with a thin broken line, the chromaticity area of Comparison Example 2 is shown with a one dot chain line, and the chromaticity area of Comparison Example 3 is shown with a two dot chain line. In FIG. 13, the chromaticity area of Comparison Example 4 is shown with a one dot chain line, and the chromaticity area of Working Example 1 is shown with a two dot chain line.

TABLE 1

| | | x | y |
|---|---|---|---|
| NTSC | R | 0.67 | 0.33 |
| | G | 0.21 | 0.71 |
| | B | 0.14 | 0.08 |
| Comparison | R | 0.648 | 0.339 |
| Example 1 | G | 0.302 | 0.649 |
| | B | 0.152 | 0.061 |
| Comparison | R | 0.692 | 0.298 |
| Example 2 | G | 0.218 | 0.695 |
| | B | 0.147 | 0.084 |
| Comparison | R | 0.672 | 0.319 |
| Example 3 | G | 0.244 | 0.669 |
| | B | 0.146 | 0.083 |
| Comparison | R | 0.704 | 0.296 |
| Example 4 | G | 0.213 | 0.731 |
| | B | 0.151 | 0.027 |
| Working | R | 0.676 | 0.315 |
| Example 1 | G | 0.210 | 0.731 |
| | B | 0.150 | 0.029 |

Furthermore, Table 2 below shows NTSC area ratios of respective chromaticity areas for images displayed in Comparison Examples 1 to 4 and Working Example 2, and Table 3 below shows NTSC coordinate coverage ratios of respective chromaticity areas for images displayed in Comparison Examples 1 to 4 and Working Example 2. The “NTSC area ratios” in Table 2 are ratios (percentages) of areas of the respective chromaticity areas for images displayed in Comparison Examples 1 to 4 and Working Example 1 in relation to the area of the NTSC chromaticity area. The “NTSC coordinate coverage ratios” of Table 3 are the ratio of the area of overlap between the NTSC chromaticity area and the respective chromaticity areas of images displayed in Comparison Examples 1 to 4 and Working Example 1 in relation to the NTSC chromaticity area.

TABLE 2

| | NTSC Area |
|---|---|
| | Ratio (%) |
| Comparison | 78.9 |
| Example 1 | |
| Comparison | 100.5 |
| Example 2 | |
| Comparison | 90.1 |
| Example 3 | |
| Comparison | 117.8 |
| Example 4 | |
| Working | 111.4 |
| Example 1 | |

TABLE 3

| | NTSC Coordinate |
|---|---|
| | Coverage Ratio (%) |
| Comparison | 75.9 |
| Example 1 | |
| Comparison | 93.7 |
| Example 2 | |
| Comparison | 88.2 |
| Example 3 | |
| Comparison | 96.5 |
| Example 4 | |
| Working | 97.1 |
| Example 1 | |

Next, experiment results shown in Tables 1 to 3 and FIGS. 12 and 13 will be described. First, when comparing Comparison Examples 1 to 3, it can be seen that Comparison Examples 2 and 3 have larger chromaticity areas that Comparison Example 1 (Tables 1 to 3 and FIG. 12). Specifically, in Comparison Examples 2 and 3, the chromaticity areas for red and green are larger than those of Comparison Example 1, which means that the NTSC area ratio and the NTSC coordinate coverage ratio are both larger in Comparison Examples 2 and 3 than in Comparison Example 1. The reason for this is thought to be that the emission spectrum of white LEDs in Comparison Example 1 have wide and smooth peaks for the green wavelength region (close to 550 nm) and the red wavelength region (close to 650 nm) as shown in FIG. 14, and the wavelength region between these peaks (550 nm to 650 nm) includes light having an intensity greater than a certain amount, which means that the color purity of light transmitted through the green colored portions and the red colored portions included among the color filters is relatively low (see FIGS. 9 and 15). Also, when comparing Comparison Examples 2 and 3, Comparison Example 2 has a larger chromaticity area than Comparison Example 3. Specifically, Comparison Example 2 has wider chromaticity areas for red and green than in Comparison Example 3, but the chromaticity area for blue is approximately equal to that of Comparison Example 3. This results from the difference between the emission spectra of the LEDs of the three colors in Comparison Example 2 and the emission spectra of the two colors in Comparison Example 3. Specifically, as shown in FIG. 9, the magenta LEDs of Comparison Example 3 have a wide and smooth peak in the red wavelength region (close to 650 nm) in the emission spectrum thereof, and light having an intensity greater than a certain amount is included in the greenish wavelength region (close to 580 nm). Thus, the color purity of light transmitted through the red colored portions and the green colored portions included among the color filters is relatively low. On the other hand, as shown in FIG. 15, the red LEDs of Comparison Example 3 has a narrow and steep peak in the emission spectrum thereof, and almost no light having an intensity greater than a certain amount is included in the greenish wavelength region. Thus, the color purity of light transmitted through the red colored portions and the green colored portions included among the color filters is relatively high.

Next, when comparing Comparison Examples 2 and 4 having LEDs of three colors, Comparison Example 4 has a greater chromaticity area than Comparison Example 2 (Tables 1 to 3 and FIG. 13). Similarly, when comparing Comparison Example 3 and Working Example 1 having LEDs of two colors, Working Example 1 has a greater chromaticity area than Comparison Example 3. Specifically, Comparison Example 4 and Working Example 1 have greater chromaticity areas for red, green, and blue than Comparison Examples 2 and 3. This is thought to be because the liquid crystal panel and the backlight device are driven at a split timing, and during the display periods of the respective colors, LEDs emitting light other than that corresponding to a given display period, or in other words, LEDs emitting light of a color that is not to be displayed are turned OFF, preventing such light from being radiated to the liquid crystal panel, and thus, the color purity of light transmitted through the colored portions included among the color filters is high.

When comparing Comparison Example 4 and Working Example 1 in which the liquid crystal panel and backlight device are driven at a split timing, Comparison Example 4 has a greater chromaticity area than Working Example 1. Specifically, Comparison Example 4 has a greater chromaticity area for red than Working Example 1, but the chromaticity areas for green and blue are generally equal to those of Working Example 1. In other words, Working Example 1 has equal chromaticity areas to Comparison Example 4 with the exception of the red chromaticity area. This results from a difference between the emission spectrum of the red LEDs of Comparison Example 4 and the emission spectrum of the magenta LEDs 17M of Working Example 1. Specifically, as shown in FIG. 9, the magenta LEDs 17M have a relatively wide and low peak in the red wavelength region (close to 650 nm) in the emission spectrum thereof, whereas the red LEDs of Comparison Example 4 have a relatively narrow and high peak (close to 650 nm) in the emission spectrum thereof, as shown in FIG. 15.

This means that Comparison Example 4 has better color reproduction than Working Example 1. However, in Comparison Example 4, there are three display periods included in each frame period, and the display period for each color is short at approximately 1/180 s (approximately 5.55 ms). If the duty ratio per display period is low, the user of the liquid crystal display device sees the R, G, and B colors separately, causing so-called color breakup. Thus, while the color reproduction of Comparison Example 4 is better than that of Working Example 1, this is limited to the red chromaticity area, and does not greatly make up for the disadvantage posed by the low duty ratio. By contrast, in Working Example 1, there are two display periods per frame period, which means the duty ratio is greater per display period, thereby making color breakup unlikely. Additionally, Working Example 1 does not have a worse color reproduction than Comparison Example 4 with the exception of the red chromaticity area, thereby achieving a balance between preventing color breakup and improving color reproduction. Another point to be made is that the NTSC coordinate coverage ratio of Working Example 1 in Table 3 exceeds that of Comparison Example 4, and thus, Working Example 1 sufficiently satisfies the NTSC standards, thereby guaranteeing excellent color reproduction.

Also, when comparing Working Example 1 to a conventional technique in which the liquid crystal panel is provided with cyan sub-pixels and yellow sub-pixels, in the conventional technique, greenish wavelength light included in light emitted by the red LEDs and blue LEDs can pass through the cyan sub-pixels and the yellow sub-pixels during the first driving period, and thus, there was a risk that color purity of the transmitted light would be worsened. Similarly, during the second driving period, reddish wavelength light and bluish wavelength light included in light emitted by the green LEDs can pass through the cyan sub-pixels and the yellow sub-pixels, and thus, there was a risk that the color purity of the transmitted light would be worsened. In Working Example 1, the light emitted by the magenta LEDs during the red-and-blue display period passes through the red pixels RPX and the blue pixels BPX, which selectively allow through red light and blue light but not green light. Thus, the color purity of the transmitted light can be made high. Also, during the green display period, the light emitted by the green LEDs passes through the green pixels GPX, which selectively allow through green light but not red light or blue light, and thus, the color purity of the transmitted light can be made high. Furthermore, whereas in the conventional technique, the need for a specially designed liquid crystal panel provided with cyan sub-pixels and yellow sub-pixels meant a higher manufacturing cost, in Working Example 1, a typical liquid crystal panel 11 having red, green, and blue color filters is used, and thus, the manufacturing cost can be kept low.

As described above, the liquid crystal display device 10 (display device) of the present embodiment includes: a liquid crystal panel 11 (display panel) that displays images and has red pixels RPX that selectively allow through red light, blue pixels BPX that selectively allow through blue light, and green pixels GPX that allow through at least green light; a backlight device 12 (illumination device) for supplying light for image display in the liquid crystal panel 11, the backlight device 12 having magenta LEDs 17M (magenta light sources) that emit magenta light and green LEDs 17G (green light sources) that emit green light; a panel control unit 50 that controls a liquid crystal panel 11 so as to include in each frame period a red-and-blue display period during which the red pixels RPX and the blue pixels BPX are selectively driven to display red and blue, and a green display period during which the green pixels GPX are selectively driven to display green; and a backlight control unit 51 (illumination control unit) that controls the backlight device 12 such that the magenta LEDs 17M are turned ON and the green LEDs 17G are turned OFF during the red-and-blue display period, and the green LEDs 17G are turned ON and the magenta LEDs 17M are turned OFF during the green display period.

In this manner, during the red-and-blue display period included in each frame period, the panel control unit 50 selectively drives the red pixels RPX and the blue pixels BPX, and the backlight control unit 51 turns ON the magenta LEDs 17M while turning OFF the green LEDs 17G. When this happens, the magenta light emitted by the magenta LEDs 17M passes through the red pixels RPX driven in the liquid crystal panel 11 such that red transmitted light is obtained, and the magenta light passes through the driven blue pixels BPX such that blue transmitted light is obtained, thereby displaying red and blue. At this time, the green LEDs 17G are turned OFF, and thus, the color purity of light transmitted through the red pixels RPX and the blue pixels BPX is high. Furthermore, the red pixels RPX selectively allow through red light and the blue pixels BPX selectively allow through blue light, and almost no light of other colors (such as green light) passes through, which allows the color purity of the transmitted light to be high.

During the green display period included in each frame period, the panel control unit 50 selectively drives the green pixels GPX, and the backlight control unit 51 turns ON the green LEDs 17G and turns OFF the magenta LEDs 17M. When this happens, the green light emitted by the green LEDs 17G passes through the green pixels GPX in the liquid crystal panel 11, and thus, green is displayed. At this time, the magenta LEDs 17M are turned OFF, and thus, the color purity of light transmitted through the green pixels GPX is high.

By including the red-and-blue display period and the green display period in each frame period as described above, it is possible to display images in the liquid crystal panel 11 with the images having a high color reproduction. Color image display is realized by including the red-and-blue display period and the green display period in each frame period, and thus, compared to a case in which there are three or more display periods included in each frame period, it is possible to increase the duty ratio for each display period, and it is possible for the panel control unit 50 to control the liquid crystal panel 11 with ease and for the backlight control unit 51 to control the backlight device 12 with ease.

The green pixels GPX selectively allows through green light. In this manner, the liquid crystal panel 11 has red pixels RPX, green pixels GPX, and blue pixels BPX, which respectively emit light of the three primary colors, and thus, a typical liquid crystal panel 11 can be used, which presents a cost advantage. The green pixels GPX selectively allow through green light and do not allow through light of other colors (such as red light or blue light), and thus, it is possible to make the color purity of the light transmitted through the green pixels GPX during the green display period high, which allows excellent color reproduction.

Also, the magenta LEDs 17M have blue LED elements 40B (blue light-emitting element), which emit blue light, and a red phosphor that emits red light by being excited by the blue light emitted by the blue LED elements 40B. In this manner, the control circuit for the magenta LEDs 17M in the backlight control unit 51 becomes simpler and the driving of the magenta LEDs 17M is easier compared to a case in which the magenta LEDs 17M are formed of a group including a red LED that emits red light and blue LED that emits blue light. Also, the light emitted by the magenta LEDs 17M is magenta light in which the red light and the blue light are mixed together, which mitigates the occurrence of so-called color breakup.

The green LEDs 17G have green LED elements 40G (green light-emitting elements) that emit green light, and the green LED elements 40G in the green LEDs 17G and the blue LED elements 40B in the magenta LEDs 17M are made of the same semiconductor material. Thus, the drive voltages for the green LED elements 40G and the blue LED elements 40B are approximately the same, and thus, a common power source can be used for the backlight control unit 51, which drives the green LEDs 17G and the magenta LEDs 17M. Also, the green LED elements 40G and the blue LED elements 40B have similar temperature characteristics, which mitigates uneven color resulting from chromaticity change in the emitted light occurring due to temperature change. Furthermore, the above-mentioned semiconductor material is InGaN. This allows for good light-emission efficiency and low manufacturing cost.

### Embodiment 2

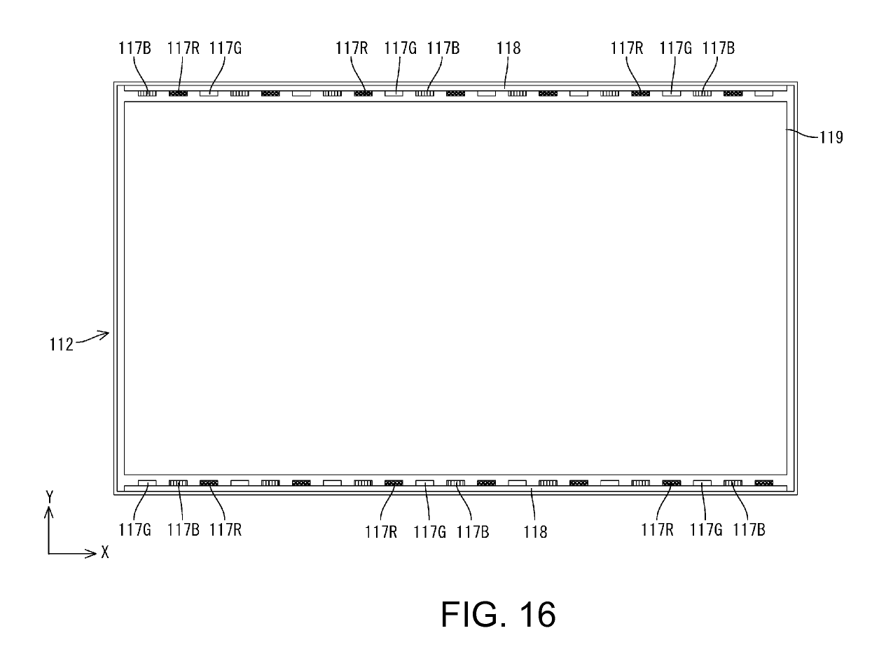

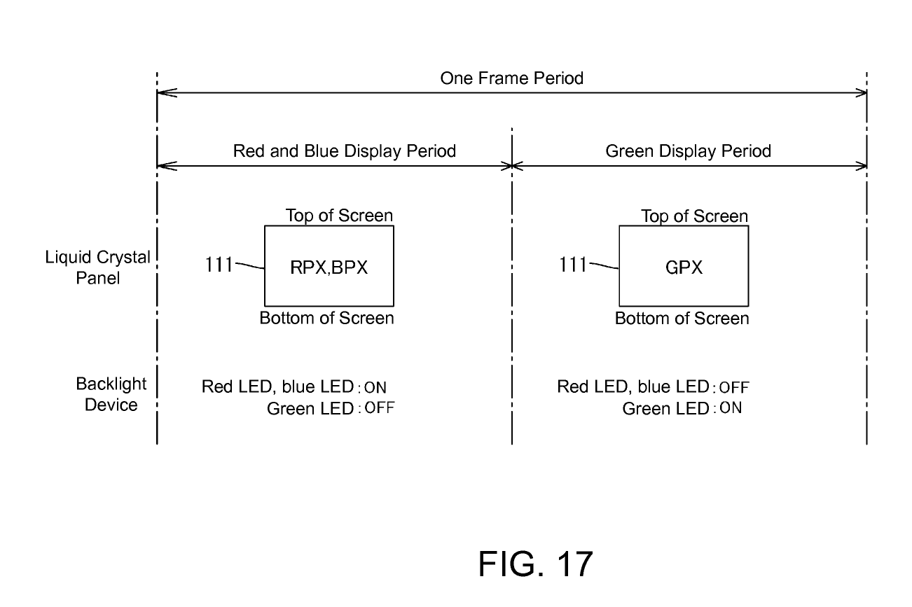

Embodiment 2 of the present invention will be described with reference to FIGS. 16 and 17. In Embodiment 2, the configuration of light sources used in the backlight device 112 is modified. Descriptions of structures, operations, and effects similar to those of Embodiment 1 will be omitted.

As shown in FIG. 16, the backlight device 112 of the present embodiment has red LEDs 117R, green LEDs 117G, and blue LEDs 117B as the light sources, including the red LEDs 117R and the blue LEDs 117B instead of the magenta LEDs 17M in Embodiment 1. The red LEDs 117R and the blue LEDs 117B are similar to the red LEDs 17R and the blue LEDs 17B of Comparison Examples 2 and 4 in Comparison Experiment 1 of Embodiment 1, and the emission spectra thereof are as shown in FIG. 14. The red LEDs 117R, the green LEDs 117G, and the blue LEDs 117B are disposed alternately on the LED substrates 118 in the length direction thereof. FIG. 16 shows the red LEDs 117R and blue LEDs 117B with different shading. The wiring patterns formed on the LED substrates 118 include a red wiring pattern for connecting the plurality of red LEDs 117R to each other in series, a green wiring pattern for connecting the plurality of green LEDs 117G to each other in series, and a blue wiring pattern for connecting the plurality of blue LEDs 117B to each other in series. As a result, the plurality of red LEDs 117R, the plurality of green LEDs 117G, and the plurality of blue LEDs 117B mounted on the same LED substrate 118 are driven independently from each other to control the timing at which they are ON or OFF, the luminance thereof, and the like. Of the pair of LED substrates 118 on both sides of the light guide plate 119, the red LEDs 117R, the green LEDs 117G, and the blue LEDs 117B of one LED substrate 118 are arranged so as not to face the same color red LEDs 117R, green LEDs 117G, and blue LEDs 117B mounted on the other LED substrate 118. In other words, the red LEDs 117R on the LED substrate 118 at the top of FIG. 16 are in the same position in the X axis direction as the blue LEDs 117B on the LED substrate 118 at the bottom of FIG. 16 (these LEDs face each other in the Y axis direction across the light guide plate 119). The green LEDs 117G on the LED substrate 118 at the top of FIG. 16 are at the same position in the X axis direction as the red LEDs 117R on the LED substrate 118 at the bottom of FIG. 16. The blue LEDs 117B on the LED substrate 118 at the top of FIG. 16 are at the same position in the X axis direction as the green LEDs 117G on the LED substrate 118 at the bottom of FIG. 16.

By modifying the arrangement of light sources in the backlight device 112 in this manner, the controlling of the backlight device 112 is also modified in the following manner. As shown in FIG. 17, the backlight control unit (not shown) controls the backlight device 112 such that during the red-and-blue display period included in each frame period, the red LEDs 117R and the blue LEDs 117B are turned ON and the green LEDs 117G are turned OFF, and such that during the green display period, the green LEDs 117G are turned ON and the red LEDs 117R and the blue LEDs 117B are turned OFF. As a result, effects similar to those of Embodiment 1 are attained, and by using red LEDs 117R and blue LEDs 117B instead of the magenta LEDs 17M, the color purity of red light in particular can be increased, thereby further improving color reproduction.

<Comparison Experiment 2>

Next, Comparison Experiment 2 will be described. In Comparison Experiment 2, the liquid crystal display device having the backlight device 112 mentioned above is Working Example 2. The chromaticity of images displayed therein is measured, and the measurement results are compared with the measurement results of Comparison Example 4 in Comparison Experiment 1 and Working Example 1.

In Working Example 2, red LEDs 117R that emit red light, green LEDs 117G that emit green light, and blue LEDs 117B that emit blue light are used as the light sources of the backlight device 112. Each frame period includes a red-and-blue display period during which red and blue are displayed by selectively driving the red pixels RPX and the blue pixels BPX in the liquid crystal panel 111, and a green display period during which green is displayed by selectively driving the green pixels GPX. Also, during the red-and-blue display period, the red LEDs 117R and the blue LEDs 117B are illuminated, and during the green display period, only the green LEDs 117G are illuminated, thereby displaying images in the liquid crystal panel 111, and the chromaticity of images displayed therein is measured by spectrophotometry, for example. The measurement results of Working Example 2 are shown in Tables 4 to 6 below along with the measurement results of Comparison Example 4 and Working Example 1 of Comparison Experiment 1. The respective parameters (R, G, B, x, y) in Table 4 are similar to those of Table 1, the parameter of Table 5 (NTSC area ratio) is similar to that of Table 2, and the parameter of Table 6 (NTSC coordinate coverage ratio) is similar to that of Table 3.

TABLE 4

| | | x | y |
|---|---|---|---|
| NTSC | R | 0.67 | 0.33 |
| | G | 0.21 | 0.71 |
| | B | 0.14 | 0.08 |
| Comparison | R | 0.704 | 0.296 |
| Example 4 | G | 0.213 | 0.731 |
| | B | 0.151 | 0.027 |
| Working | R | 0.676 | 0.315 |
| Example 1 | G | 0.210 | 0.731 |
| | B | 0.150 | 0.029 |
| Working | R | 0.698 | 0.293 |
| Example 2 | G | 0.213 | 0.731 |
| | B | 0.152 | 0.027 |

TABLE 5

| | NTSC Area |
|---|---|
| | Ratio (%) |
| Comparison | 117.8 |
| Example 4 | |
| Working | 111.4 |
| Example 1 | |
| Working | 116.4 |
| Example 2 | |

TABLE 6

| | NTSC Coordinate |
|---|---|
| | Coverage Ratio (%) |
| Comparison | 96.5 |
| Example 4 | |
| Working | 97.1 |
| Example 1 | |
| Working | 96.0 |
| Example 2 | |

Next, the experiment results shown in Tables 4 to 6 will be described. The driving of the liquid crystal panel and the backlight device is similar between Working Examples 1 and 2 but the configuration of the light sources differs therebetween. Namely, the chromaticity area of Working Example 2 is greater than that of Working Example 1. Specifically, Working Example 2 has generally similar chromaticity areas for green and blue as in Working Example 1, but the red chromaticity area is greater than that of Working Example 1. This results from a difference in the emission spectrum of the red LEDs 117R of Working Example 2 and the emission spectrum of the magenta LEDs 17M of Working Example 1. Specifically, the magenta LEDs 17M of Working Example 1 have a relatively wider and lower peak in the red wavelength region (close to 650 nm) in the emission spectrum thereof (see FIG. 9), whereas the red LEDs 117R of Working Example 2 have a relatively narrow and high peak (close to 650 nm) in the red wavelength region in the emission spectrum thereof.

Next, the configuration of the light sources is similar between Working Example 2 and Comparison Example 4, but the driving of the liquid crystal panel and the backlight device differs therebetween, and when comparing the two, the chromaticity areas are almost the same. This is because, while there are two display periods per frame period in Working Example 2, there are three display periods per frame period in Comparison Example 4, as long as the configuration of the light sources is similar, the color reproduction is similar therebetween. Therefore, according to Working Example 2, it is possible to prevent color breakup by having a high duty ratio per display period, while attaining the same excellent color reproduction as Comparison Example 4. The chromaticity coordinates of the three primary colors of Working Example 2 shown in Table 4 differ only slightly from the chromaticity coordinates of the three primary colors of Comparison Example 4, and even when shown in graphs such as those in FIGS. 12 and 13, the regions mostly overlap, and thus, no graphs thereof are shown.

As described above, according to the present embodiment, the magenta LEDs 117M include red LEDs 117R (red light sources) that emit red light and blue LEDs 117B (blue light sources) that emit blue light. In this manner, compared to a case in which the magenta LEDs include a blue light-emitting element that emits blue light and a red phosphor that emits red light by being excited by the blue light emitted from the blue light-emitting element, the color purity for red light and blue light can be made higher. Thus, it is possible to have a higher color reproduction for color images displayed in the liquid crystal panel 111.

### Embodiment 3

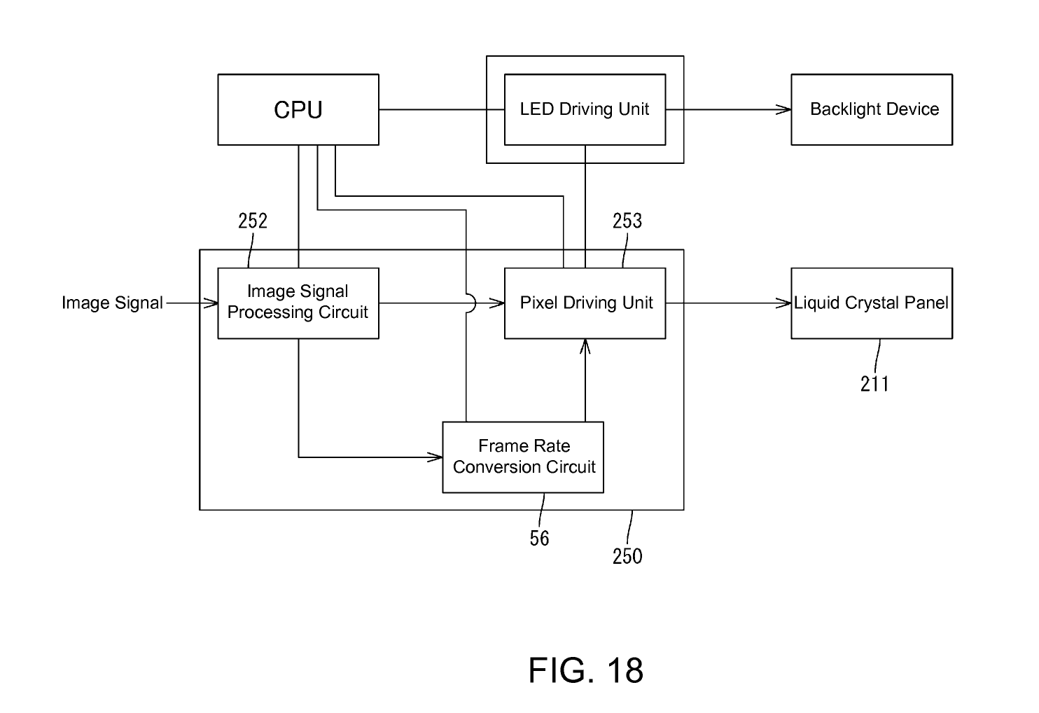

Embodiment 3 of the present invention will be described with reference to FIG. 18. In Embodiment 3, a panel control unit 250 includes a frame rate conversion circuit 56. Descriptions of structures, operations, and effects similar to those of Embodiment 1 will be omitted.

As shown in FIG. 18, the panel control unit 250 of the present embodiment has a frame rate conversion circuit 56 that converts the frame rate in a signal outputted from an image signal processing circuit 252, which processes image signals, and supplies the converted frame rate to a pixel driving unit 253. The frame rate conversion circuit 56 has a so-called double-speed driver circuit that doubles, for example, the frame rate of the processed signal outputted from the image signal processing circuit 252. Specifically, if the processed signal outputted from the image signal processing circuit 252 has a frame rate of approximately 60 fps, for example, then the frame rate conversion circuit 56 converts the frame rate of the outputted signal to approximately 120 fps and supplies this signal to the pixel driving unit 253. The pixel driving unit 253 drives the red pixels RPX, the green pixels GPX, and the blue pixels BPX of the liquid crystal panel 211 such that there are 60 red-and-blue display periods and green display periods per second, or in other words, half the frame rate as converted by the frame rate conversion circuit 56. By doubling the frame rate by the frame rate conversion circuit 56, the video responsiveness can be improved. Also, whereas a specialized image signal processing circuit would be necessary if the image signal processing circuit of Embodiment 1, which is not provided with the frame rate conversion circuit 56, were to be designed to supply an approximately 120 fps output signal to the pixel driving unit, in the present embodiment, it is possible to use a general use image signal processing circuit 252 having an output signal of approximately 60 fps, and thus, this presents an advantage in manufacturing cost.

According to the present embodiment described above, the panel control unit 250 includes the image signal processing circuit 252 that processes images, the pixel driving unit 253 that drives the red pixels RPX, the green pixels GPX, and the blue pixels BPX on the basis of signals outputted from the image signal processing circuit 252, and the frame rate conversion circuit 56 that can covert the frame rate of the signal outputted from the image signal processing circuit 252 and supply it to the pixel driving unit 253. In this manner, by converting the frame rate of signals outputted from the image signal processing circuit 252 using the frame rate conversion circuit 56 and supplying the signal to the pixel driving unit 253, it is possible to perform driving in which the red-and-blue display period and the green display period are included in each frame period. A general use double-speed driver circuit 56 can use a general use double-speed driver circuit, for example, which is useful for cutting costs.

### Embodiment 4

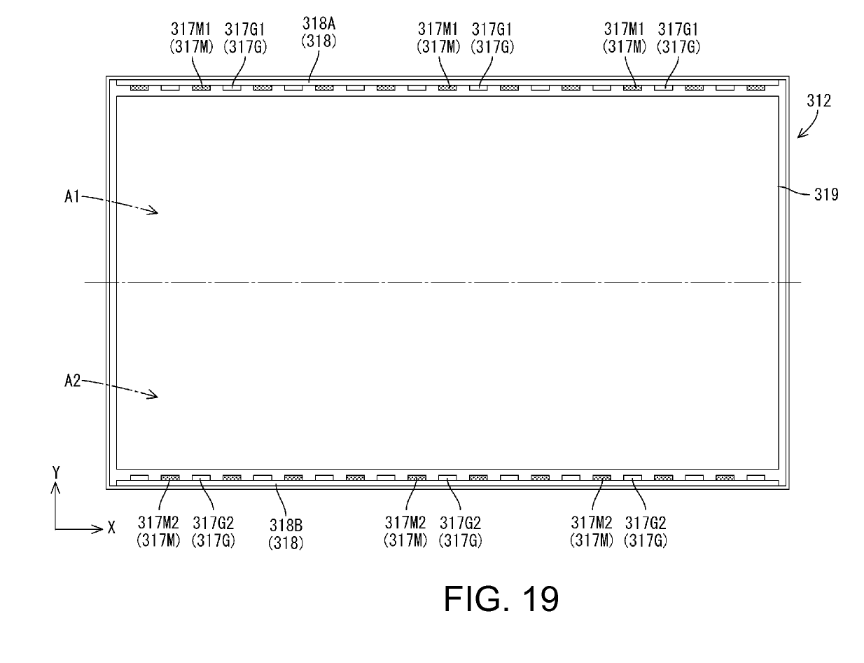

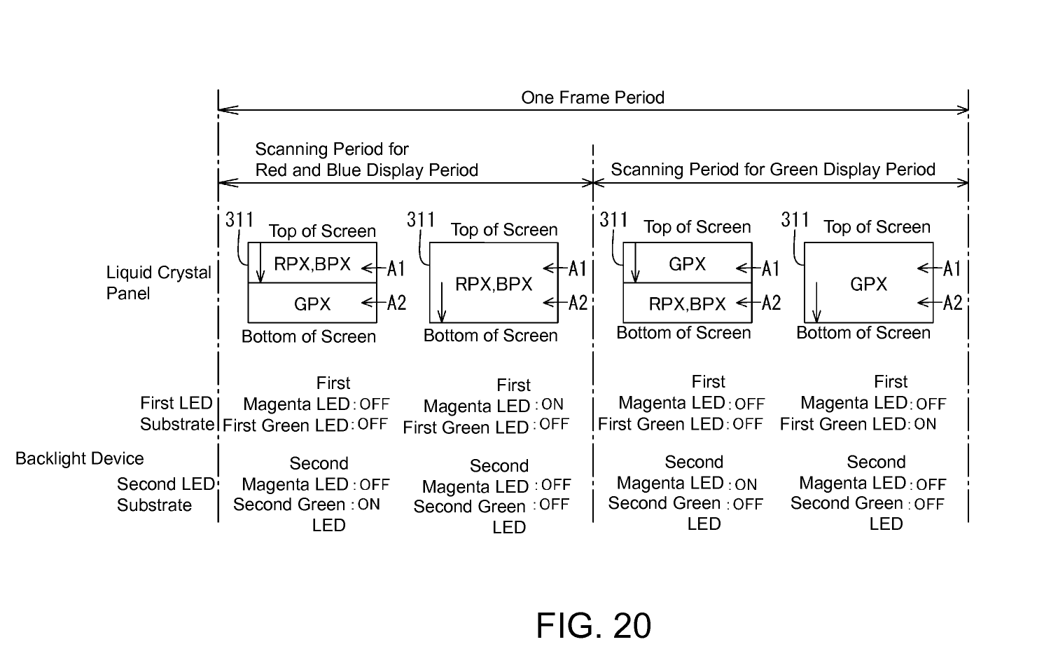

Embodiment 4 of the present invention will be described with reference to FIG. 19 or 20. In Embodiment 4, the respective pixels RPX, GPX, and BPX of the liquid crystal panel 311 and the LEDs 317G and 317M of the backlight device 312 are driven according to a split timing. Descriptions of structures, operations, and effects similar to those of Embodiment 1 will be omitted.

As shown in FIG. 19, in the present embodiment, the liquid crystal panel 311 is divided into a first region A1 that is towards the top of the screen relatively close to where scanning starts in the column direction (Y axis direction) of the pixels RPX, GPX, and BPX arranged in a matrix, and a second region A2 that is towards the bottom of the screen relatively far from where scanning starts. Meanwhile, the backlight device 312 has two types of magenta LEDs 317M and two types of green LEDs 317G: first magenta LEDs 317M1 and first green LEDs 317G1 that supply light to the first region A1; and second magenta LEDs 317M2 and second green LEDs 317G2 that supply light to the second region A2. In FIG. 19, the boundary between the first region A1 and the second region A2 in the liquid crystal panel 311 is indicated with the one dot chain line. Specifically, the LEDs 317G and 317M mounted on the top LED substrate 318 in FIG. 19 among the pair of LED substrates 318 on both sides of the light guide plate 319 are the first magenta LEDs 317M1 and the first green LEDs 317G1, whereas the LEDs 317G and 317M mounted on the bottom LED substrate 318 in the same drawing are second magenta LEDs 317M2 and second green LEDs 317G2. The LED substrate 318 on which the first magenta LEDs 317M1 and the first green LEDs 317G1 are mounted is the first LED substrate 318A, and the LED substrate 318 on which the second magenta LEDs 317M2 and the second green LEDs 317G2 are mounted is the second LED substrate 318B. Here, a light scattering portion that causes light propagating through the light guide plate 319 to be scattered and emitted has an area distribution in which the area taken up by the light scattering portion is larger the farther away from the LEDs 317 in the Y axis direction it is such that it takes up the most area in the central portion (on the two dot chain line in FIG. 19), and in a configuration in which the pair of LED substrates 318 sandwiches the light guide plate 319 in a symmetrical manner as in the present embodiment, the area distribution of the light scattering portion is also similarly symmetrical. As a result, most of the light from the first magenta LEDs 317M1 and the first green LEDs 317G1 mounted on the first LED substrate 318A is radiated to the first region 317A1 of the liquid crystal panel 311, whereas the most of the light from the second magenta LEDs 317M2 and the second green LEDs 317G2 is radiated to the second region A2 in the liquid crystal panel 311.

Next, the controlling of the backlight device 312 will be described with reference to FIG. 20. FIG. 20 shows the scanning period of the red-and-blue display period and the scanning period of the green display period both split in half. Specifically, the left end of FIG. 20 shows a period from when scanning of the red pixels RPX and the blue pixels BPX belonging to the first region A1 starts to when the scanning ends (first half of scanning period of red-and-blue display period), the second from the left end shows a period from when scanning of the red pixels RPX and the blue pixels BPX belonging to the second region A2 starts to when the scanning ends (second half of scanning period of red-and-blue display period), the third from the left end shows a period from when scanning of the green pixels GPX belonging to the first region A1 starts to when the scanning ends (first half of scanning period of green display period), and the right end shows a period from when scanning of the green pixels GPX belonging to the second region A2 starts to when the scanning ends (second half of scanning period of green display period). The scanning of the pixels RPX, GPX, and BPX is performed sequentially in the Y axis direction, or in other words, the top of the screen to the bottom of the screen along the arrow indicated in the liquid crystal panel 311 of FIG. 19.

The backlight control unit controlling the backlight device 312 controls the driving of the LEDs 317G and 317M in the following manner in synchronization with the scanning of the respective regions A1 and A2. That is, the backlight control unit turns OFF both the first magenta LEDs 317M1 and the first green LEDs 317G1 during a period from when scanning of the red pixels RPX and the blue pixels BPX belonging to the first region A1 starts during the red-and-blue display period to when the scanning ends (period shown on left of FIG. 20). During the period from when this scanning ends to when scanning during the green display period starts (until the third from left period in FIG. 20 is reached), or in other words, the period from when scanning of the red pixels RPX and the blue pixels BPX belonging to the second region A2 starts to when the scanning ends (second from left period in FIG. 20), the first magenta LEDs 317M1 are turned on but the first green LEDs 317G1 are turned OFF. During the period from when scanning of the red pixels RPX and the blue pixels BPX belonging to the second region A2 begins during the red-and-blue display period to when the scanning ends (second from left period in FIG. 20), both the second magenta LEDs 317M2 and the second green LEDs 317G2 are OFF. During the period from when this scanning ends to when scanning during the subsequent green display period starts (until the period on the right end of FIG. 20), or in other words, the period from when the scanning of the green pixels GPX belonging to the first region A1 during the green display period begins to when the scanning ends (third from left period in FIG. 20), the second magenta LEDs 317M2 are turned ON and the second green LEDs 317G2 are turned OFF. The period during which the first magenta LEDs 317M1 and the second magenta LEDs 317M2 are turned ON (second from left and third from left periods in FIG. 20) is the red-and-blue display period during which red and blue are displayed in the liquid crystal panel 311.

In this manner, the pixels RPX, GPX, and BPX belonging to the respective regions A1 and A2 are supplied magenta light from the magenta LEDs 317M1 and 317M2 from when the scanning of the red-and-blue display period ends to when the scanning of the subsequent green display period starts, thereby displaying red and blue in the display surface of the liquid crystal panel 311. In the regions A1 and A2, during the period from when the scanning of the red-and-blue display period starts to when the scanning ends, the LEDs 317G1, 317G2, 317M1, and 317M2, which can supply light to the respective regions A1 and A2 where scanning is performed, are turned OFF, and thus, light is prevented from entering the respective pixels RPX, GPX, and BPX in the middle of scanning. Thus, the color purity of light transmitted through the pixels RPX, GPX, and BPX is made higher, and the color reproduction is excellent.

On the other hand, the panel control unit causes the first green LEDs 317G1 and the first magenta LEDs 317M1 to both be OFF from when scanning of the green pixels GPX belonging to the first region A1 starts during the green display period to when the scanning ends (third period from the left in FIG. 20). During the period from when this scanning ends to when the subsequent scanning during the red-and-blue display period starts (until the period shown on the left edge of FIG. 20), or in other words, the period when scanning of the green pixels GPX belonging to the second region A2 starts during the green display period (period on the right edge of FIG. 20), the first green LEDs 317G1 are turned ON and the first magenta LEDs 317M1 are turned OFF. Next, during the period from when scanning of the green pixels GPX belonging to the second region A2 starts during the green display period (period on the right edge of FIG. 20), the second magenta LEDs 317M2 and the second green LEDs 317G2 are both OFF. During the period from when this scanning ends to when scanning during the subsequent red-and-blue display period starts (period up to the second from left period in FIG. 20), or in other words, from the period from when scanning of the red pixels RPX and the blue pixels BPX belonging to the first region A1 starts during the red-and-blue display period to when this scanning ends (period on left edge of FIG. 20), the second green LEDs 317G2 are turned ON and the second magenta LEDs 317M2 are turned OFF. The periods when the first green LEDs 317G1 and the second green LEDs 317G2 are turned ON (rightmost period and leftmost period in FIG. 20) are green display periods during which green is displayed in the liquid crystal panel 311.

In this manner, the respective pixels RPX, GPX, and BPX belonging to the regions A1 and A2 are supplied green light from the green LEDs 317G1 and 317G2 from when the scanning of the green display period ends to when the scanning of the subsequent red-and-blue display period starts, and thus, green display is performed on the display surface of the liquid crystal panel 311. In the regions A1 and A2, during the period from when the scanning of the green display period starts to when the scanning ends, the LEDs 317G1, 317G2, 317M1, and 317M2, which can supply light to the respective regions A1 and A2 where scanning is performed, are turned OFF, and thus, light is prevented from entering the respective pixels RPX, GPX, and BPX in the middle of scanning. Thus, the color purity of light transmitted through the pixels RPX, GPX, and BPX is made higher, and the color reproduction is excellent.

As described above, according to the present embodiment, the liquid crystal panel 311 has groups of a plurality of the red pixels RPX, the green pixels GPX, and the blue pixels BPX arranged in a matrix, and the panel control unit sequentially scans in a column direction groups of pixels including the red pixels RPX, the green pixels GPX, and the blue pixels BPX arranged in a row direction on the liquid crystal panel 311, the liquid crystal panel 311 is divided into a first region A1 that is relatively close in the column direction to where scanning begins and a second region A2 that is relatively far in the column direction from where scanning begins, and the magenta LEDs 317M and the green LEDs 317G in the backlight device 312 are divided into first magenta LEDs 317M1 and first green LEDs 317G1 that supply light to the first region A1 in the column direction and second magenta LEDs 317M2 and second green LEDs 317G2 that supply light to the second region A2, the backlight control unit turns off the first magenta LEDs 317M1 and the first green LEDs 317G1 from when scanning starts to when the scanning ends during the red-and-blue display period or the green display period in the red pixels RPX and the blue pixels BPX, or the green pixels GPX belonging to the first region A1, while the backlight control unit turns ON the first magenta LEDs 317M1 or the first green LEDs 317G1 and turns OFF the first green LEDs 317G1 or the first magenta LEDs 317M1 from when the scanning ends to when scanning during the subsequent green display period or the red-and-blue display period begins, and the backlight control unit turns OFF the second magenta LEDs 317M2 and the second green LEDs 317G2 from when scanning starts to when the scanning ends during the red-and-blue display period or the green display period in the red pixels RPX and the blue pixels BPX, or the green pixels GPX belonging to the second region A2, while the backlight control unit turns ON the second magenta LEDs 317M2 or the second green LEDs 317G2 and turns OFF the second green LEDs 317G2 or the second magenta LEDs 317M2 from when the scanning ends to when scanning during the subsequent green display period or the red-and-blue display period begins.

In this manner, during the red-and-blue display period, the panel control unit sequentially scans in the column direction the group of pixels including the red pixels RPX, the green pixels GPX, and the blue pixels BPX arranged in the row direction, thereby selectively driving the red pixels RPX and the blue pixels BPX. Here, during the period when scanning of the red pixels RPX and the blue pixels BPX belonging to the first region A1 starts during the red-and-blue display period to when the scanning ends, the first magenta LEDs 317M1 and the first green LEDs 317G1 are both OFF, and during the period from when the scanning ends to when scanning during the subsequent green display period starts, the first magenta LEDs 317M1 are turned ON and the first green LEDs 317G1 are turned OFF. Next, during the period when scanning of the red pixels RPX and the blue pixels BPX belonging to the second region A2 starts during the red-and-blue display period to when the scanning ends, the second magenta LEDs 317M2 and the second green LEDs 317G2 are both OFF, and during the period from when the scanning ends to when scanning during the subsequent green display period starts, the second magenta LEDs 317M2 are turned ON and the second green LEDs 317G2 are turned OFF.

On the other hand, during the green display period, the panel control unit sequentially scans in the column direction a group of pixels including the red pixels RPX, the green pixels GPX, and the blue pixels BPX aligned in the row direction, thereby selectively driving the green pixels GPX. Here, during the period from when scanning of the green pixels GPX belonging to the first region A1 starts during the green display period to when the scanning ends, the first green LEDs 317G1 and the first magenta LEDs 317M1 are both OFF, and during the period from when this scanning ends to when the scanning during the subsequent red-and-blue display period starts, the first green LEDs 317G1 are turned ON and the first magenta LEDs 317M1 are turned OFF. Next, during the period from when scanning of the green pixels GPX belonging to the second region A2 starts during the green display period to when the scanning ends, the second magenta LEDs 317M2 and the second green LEDs 317G2 are both OFF, and during the period from when this scanning ends to when the scanning during the subsequent red-and-blue display period starts, the second green LEDs 317G2 are turned ON and the second magenta LEDs 317M2 are turned OFF.

As described above, during the period from when the scanning in the regions A1 and A2 starts to when the scanning ends, the LEDs 317G and 317M, which could supply light to the regions A1 and A2 where scanning is being performed, are turned OFF, and thus, light can be prevented from entering the respective pixels RPX, GPX, and BPX where scanning is being performed. In this manner, it is possible to maintain high color purity for light transmitted through the pixels RPX, GPX, and BPX, and color reproduction can be further improved. This is particularly suitable when the screen size of the liquid crystal panel 311 is large.

### Embodiment 5

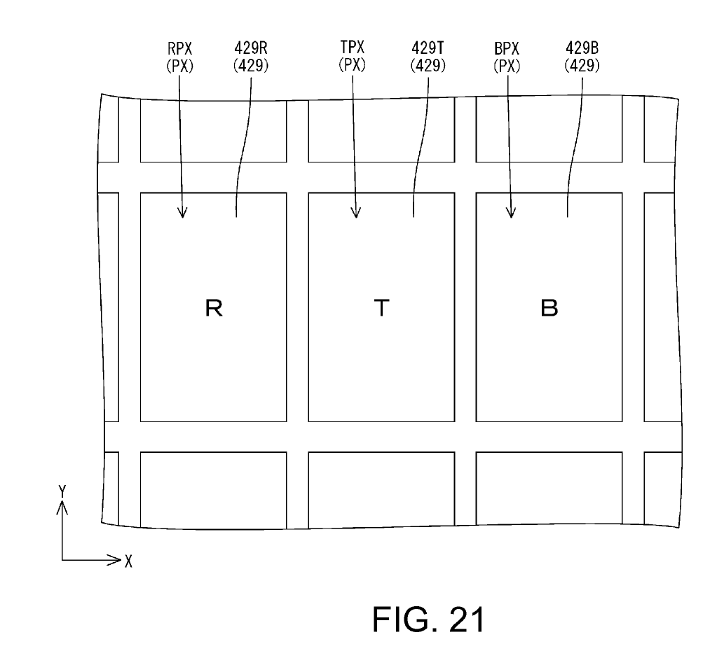

Embodiment 5 of the present invention will be described with reference to FIG. 21. In Embodiment 5, transparent pixels TPX are provided in the liquid crystal panel instead of the green pixels. Descriptions of structures, operations, and effects similar to those of Embodiment 1 will be omitted.

As shown in FIG. 21, the color filters 429 provided on the CF substrate of the liquid crystal panel of the present embodiment include red colored portions 429R that are colored red, blue colored portions 429B that are colored blue, and almost transparent uncolored portions 429T. The respective colored portions 429R and 429B and the uncolored portions 429T are arranged such that a plurality each are arranged repetitively in a matrix along the surface of the CF substrate. The uncolored portions 429T can allow through most transparent light, and do not have wavelength selectivity. Thus, the uncolored portions 429T allow through at least light in the green wavelength region. The uncolored portion 429T and the pixel electrode (not shown) opposing this constitute the transparent pixel TPX (green pixel). In other words, the unit pixels PX of the liquid crystal panel include the red pixels RPX, the blue pixels BPX, and the transparent pixels TPX. During the green display period of each frame period, the panel control unit drives the transparent pixels TPX while the backlight control unit turns ON the green LEDs and turns OFF the magenta LEDs. As a result, the transparent pixels TPX driven during the green display period do not receive magenta light from the magenta LEDs, and only receive green light from the green LEDs, and thus, display of green with a high color purity can be achieved by allowing green light through the transparent pixels TPX. The transparent pixels TPX have a higher light transmittance than the green pixels GPX in Embodiment 1 above, and thus, the color usage rate is excellent. Therefore, this configuration is advantageous in having lower power consumption and improved luminance.

As described above, according to the present embodiment, the green pixels are transparent pixels TPX that allow through all visible light. In this manner, green light from the green LEDs illuminated during the green display period passes through the driven transparent pixels TPX, which are the green pixels, to display green in the liquid crystal panel. Compared to Embodiment 1 above in which green pixels GPX that selectively allow through green light are used, the light usage rate of green light from the green LEDs improves, which is advantageous in achieving lower power consumption and improved luminance.

### Embodiment 6

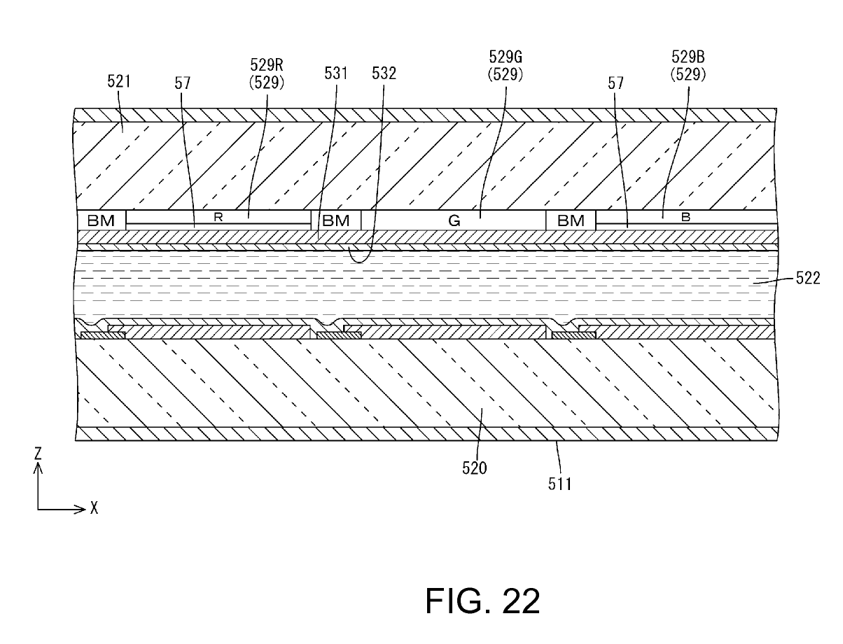

Embodiment 6 of the present invention will be described with reference to FIG. 22. In Embodiment 6, the red colored portions 529R and the blue colored portions 529B among the color filters 529 are made thinner than the green colored portions 529G. Descriptions of structures, operations, and effects similar to those of Embodiment 1 will be omitted.

As shown in FIG. 22, the color filters 529 provided on the CF substrate 521 of the liquid crystal panel 511 of the present embodiment include relatively thin red colored portions 529R and blue colored portions 529B and relatively thick green colored portions 529G. Specifically, the green colored portions 529G are substantially the same in thickness as the colored portions 29R, 29G, and 29B of the respective colors in Embodiment 1, while the red colored portions 529R and the blue colored portions 529B are thinner than this. By making the red colored portions 529R and the blue colored portions 529B thin, the light transmittance is greater, which improves light usage rate, and is therefore advantageous in attaining lower power consumption and improved luminance. The transmission spectra of the red colored portions 529R and the blue colored portions 529B have almost no overlap (see FIG. 9), and thus, the color purity of red light and blue light transmitted during the red-and-blue display period can be maintained at a sufficiently high level, which means there is almost no sacrifice of color reproduction.

The red colored portions 529R and the blue colored portions 529B have transparent spacers 57 disposed thereon, the transparent spacers having a thickness substantially equal to the difference in thickness between the green colored portion 529G, and the red and blue colored portions 529R and 529B. As a result, no difference in thickness occurs between the red and blue colored portions 529R and 529B and the green colored portions 529G, which means that steps are not formed in the opposite electrode 531 or the alignment film 532 layered on the color filters 529.

As described above, according to the present embodiment, the liquid crystal panel 511 is made by providing a liquid crystal layer 522 (substance), which changes optical characteristics in response to an applied electric field, between the pair of substrates 520 and 521, at least one of the pair of substrates 520 and 521 is provided with color filters 529 including red colored portions 529R that are colored red, green colored portions 529G that are colored green, and blue colored portions 529B that are colored blue; the red pixels RPX have the red colored portions 529R, the green pixels GPX have the green colored portions 529G, and the blue pixels BPX have the blue colored portions 529B, and the red colored portions 529R and the blue colored portions 529B are thinner than the green colored portions 529G. In this manner, the transmittance of blue and red light through the red colored portions 529R and the blue colored portions 529B, which are relatively thin, is high, which means that the light usage rate can be improved. There is little overlap between the transmission spectra of the red colored portions 529R and the blue colored portions 529B, and thus, the color purity of the blue light and the red light passing through can be maintained at a sufficiently high level, and there is almost no sacrifice of color reproduction.

### Embodiment 7

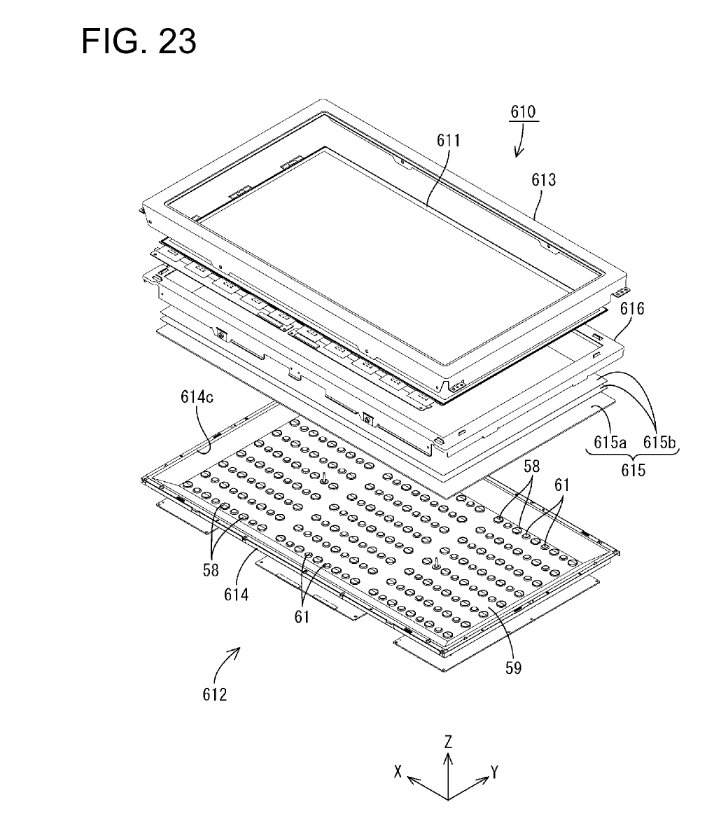

Embodiment 7 of the present invention will be described with reference to FIGS. 23 to 27. In Embodiment 7, the backlight device 612 is changed to a direct lit type, and the controls therefor are also modified. Descriptions of structures, operations, and effects similar to those of Embodiment 1 will be omitted.

As shown in FIG. 23, the liquid crystal display device 610 of the present embodiment has a liquid crystal panel 611 and a direct lit backlight device 612, which are held together integrally by a bezel 613 or the like. The configuration of the liquid crystal panel 611 is similar to that of Embodiment 1, and thus, redundant explanations therefor are omitted. The configuration of the direct lit backlight device 612 will be described below.

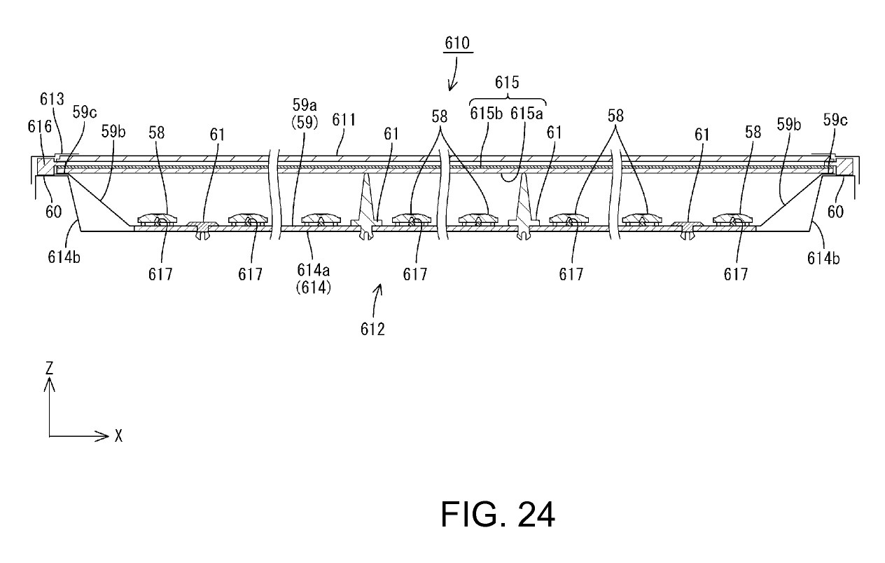

As shown in FIG. 24, the backlight device 612 includes a chassis having a substantially box shape with a light-emitting portion 614c open on the light-emission side (towards the liquid crystal panel 611), optical members 615 disposed so as to cover the light-emitting portion 614c of the chassis 614, and a frame 616 that is present along the outer edges of the chassis 614 and that holds the outer edges of the optical members 615 together with the chassis 614. LEDs 617 disposed directly under the optical members 615 (liquid crystal panel 611) to face the optical members 615, an LED substrate 618 on which the LEDs 617 are mounted, diffusion lenses 58 that are each attached to positions on the LED substrate 618 where the LEDs 617 are present, and substrate holding members 61 that hold the LED substrate 618 in place on the chassis 614 are present in the chassis 614. Also, a reflective sheet 59 that reflects light inside the chassis 614 towards the optical members 615 is present inside the chassis 614. Because the backlight device 612 of the present embodiment is of a direct lit type, no light guide plate 19, which was used in the edge lit backlight device 12 of Embodiment 1, is present. The configuration of the frame 616 is similar to that of Embodiment 1 other than the lack of the first reflective sheet R1, and thus, descriptions thereof are omitted. Next, each component of the backlight device 612 will be described in detail below.

The chassis 614 is made of metal, and as shown in FIGS. 23 and 24, includes a bottom plate 614a having a horizontally long rectangular shape similar to the liquid crystal panel 611, side plates 614b that rise up towards from front (light-emission side) from the respective outer edges of the bottom plate 614a, and a supporting plate 60 that juts outward from the upper ends of the respective side plates 614b; overall the chassis 614 has a shallow box shape open towards the front. In the chassis 614, the longer side direction thereof matches the X axis direction (horizontal direction), and the shorter side direction thereof matches the Y axis direction (vertical direction). The frame 616 and the optical members 615, which will be described next, can be mounted from the front onto the supporting plates 60 of the chassis 614. The frame 616 is screwed onto the respective supporting plates 60. The bottom plate 614a of the chassis 614 has attaching holes for respectively attaching the substrate holding members 61. The optical members 615 include a diffusion plate 615a has diffusion particles scattered inside a relatively thick base material, and two optical sheets 615b.

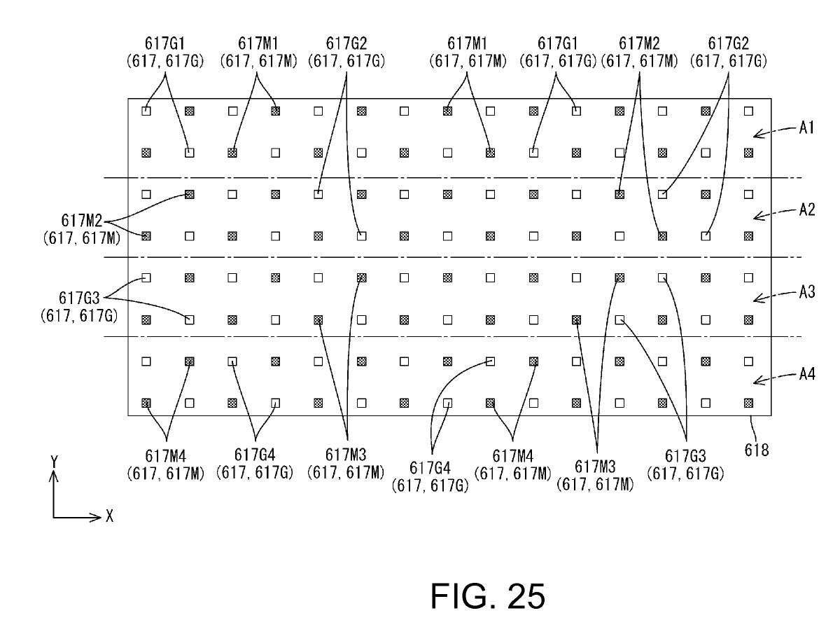

Next, the An LED substrate 618 on which the LEDs 617 are mounted will be described. As shown in FIGS. 24 and 25, the LED substrate 618 has a base material that is a horizontally long rectangle in a plan view; the LED substrate 618 is housed in the chassis 614 while extending along the bottom plate 614a such that the longer side direction thereof matches the X axis direction and the shorter side direction thereof matches the Y axis direction. Of the surfaces of the base material of the LED substrate 618, the front surface (surface facing the optical members 615) has mounted thereon the LEDs 617. In FIG. 25, the LED substrate 618 is shown with the diffusion lenses 58 removed.

As shown in FIGS. 24 and 25, a plurality each of the LEDs 617 are arranged in a matrix along the longer side direction (X axis direction) and the shorter side direction (Y axis direction) on the surface of the LED substrate 618, and the LEDs 617 are connected to each other by a prescribed wiring pattern (not shown). The light-emitting surfaces of the LEDs 617 face the optical members 615 (liquid crystal panel 611) and the optical axes thereof match the Z axis direction, or in other words, the direction perpendicular to the display surface of the liquid crystal panel 611. The LEDs 617 include magenta LEDs 617M that emit magenta light and green LEDs 617G that emit green light. The magenta LEDs 617M and the green LEDs 617G are arranged alternately in the X axis direction and the Y axis direction, or in other words, form a staggered pattern. Substantially the same number of magenta LEDs 617M and green LEDs 617G are present. In FIG. 25, the magenta LEDs 617M are shown with shading.

The diffusion lenses 58 are made of a synthetic resin material (such as polycarbonate or acryl) that is almost completely transparent (having a high degree of light transmittance) and that has a refractive index higher than air. As shown in FIGS. 23 and 24, the diffusion lenses have a prescribed thickness and are formed in a substantially circular shape in a plan view, the diffusion lenses being attached to the LED substrate 618 so as to respectively cover individual LEDs 617; in other words, the diffusion lenses 58 respectively correspond in position to the LEDs 617 in a plan view. The diffusion lenses 28 can diffuse light having a high degree of directivity from the LEDs 617 and then output this light. That is, the directivity of the light emitted from the LEDs 617 is lessened as the light passes through the diffusion lenses 27, and therefore, even when a gap between adjacent LEDs 617 is made larger, an area therebetween becomes less likely to be perceived as a dark area. This makes it possible to reduce the number of LEDs 617 that need to be provided. The diffusion lenses 58 are positioned such that the respective centers thereof substantially match the centers of the respective LEDs 617 in a plan view.

The substrate holding members 61 are made of a synthetic resin such as polycarbonate and the surface thereof has a white color having excellent light reflectivity. As shown in FIGS. 23 and 24, the substrate holding members 61 each include a main body along the surface of the LED substrate 618, and a fixture that is on rear of the main body, the fixture protruding towards the chassis 614 to be fixed thereto. Of the substrate holding members 61, a pair of substrate holding members 61 disposed towards the center of the screen is provided with support units that protrude towards the front from the main body, and the optical members 615 can be supported from the rear by the support units.

As shown in FIGS. 23 and 24, the reflective sheet 59 has a size covering almost the entire inner surface of the chassis 614; in other words, the size is large enough to cover the entire LED substrate 618 disposed along the bottom plate 614a in a plan view. The reflective sheet 59 can reflect light inside the chassis 614 towards the optical members 615. The reflective sheet 59 has a bottom section 59a extending along the bottom plate 614a of the chassis 614 and having a size large enough to cover the majority of the bottom plate 614a, four rising sections 59b that rise from the respective outer edges of the bottom section 59a while being inclined with respect thereto, and extending sections 59c extending outward from the outer edges of the rising sections 59b while being placed on the supporting plates 60 of the chassis 614. The bottom section 59a of the reflective sheet 59 is disposed so as to overlap the front surface of the respective LED substrates 618, or in other words, the surface to the front of the LEDs 617. Also, the reflective sheet 59 has holes in positions corresponding to the holes through which the respective diffusion lenses 58 are passed, and in positions corresponding to the substrate holding members 61.

As shown in FIG. 25, in the present embodiment, the liquid crystal panel 611 is divided into four regions including a first region A1 on the topmost part of the screen in the column direction (Y axis direction) of the pixels RPX, GPX, and BPX arranged in a matrix, the topmost part of the screen being where scanning starts, a second region A2 that is adjacent to the first region A1 and that is the second closest region to where scanning starts, a third region A3 that is adjacent to the second region A2 and that is the third closest region to where scanning starts, and a fourth region A4 that is adjacent to the third region A3 and is at the bottom of the screen, which is the farthest region from where scanning starts. Meanwhile, there are four different types of magenta LEDs 617M and the green LEDs 617G in the backlight device 612: first magenta LEDs 617M1 and first green LEDs 617G1 that supply light to the first region A1, second magenta LEDs 617M2 and second green LEDs 617G2 that supply light to the second region A2, third magenta LEDs 617M3 and third green LEDs 617G3 that supply light to the third region A3, and fourth magenta LEDs 617M4 and fourth green LEDs 617G4 that supply light to the fourth region A4. In FIG. 25, boundaries between the respective regions A1 to A4 in the liquid crystal panel 611 are marked with one dot chain lines. The backlight device 612 of the present embodiment is of a so-called direct lit type, and thus, the light emitted by the LEDs 617 is radiated towards regions centered around portions that overlap the surface of the opposing liquid crystal panel 611. Therefore, of the LEDs 617 mounted on the LED substrate 618, those overlapping in a plan view the first region A1 of the liquid crystal panel 611 are the first magenta LEDs 617M1 and the first green LEDs 617G1, those overlapping in a plan view the second region A2 are the second magenta LEDs 617M2 and the second green LEDs 617G2, those overlapping in a plan view the third region A3 are the third magenta LEDs 617M3 and the third green LEDs 617G3, and those overlapping in a plan view the fourth region A4 are the fourth magenta LEDs 617M4 and the fourth green LEDs 617G4.

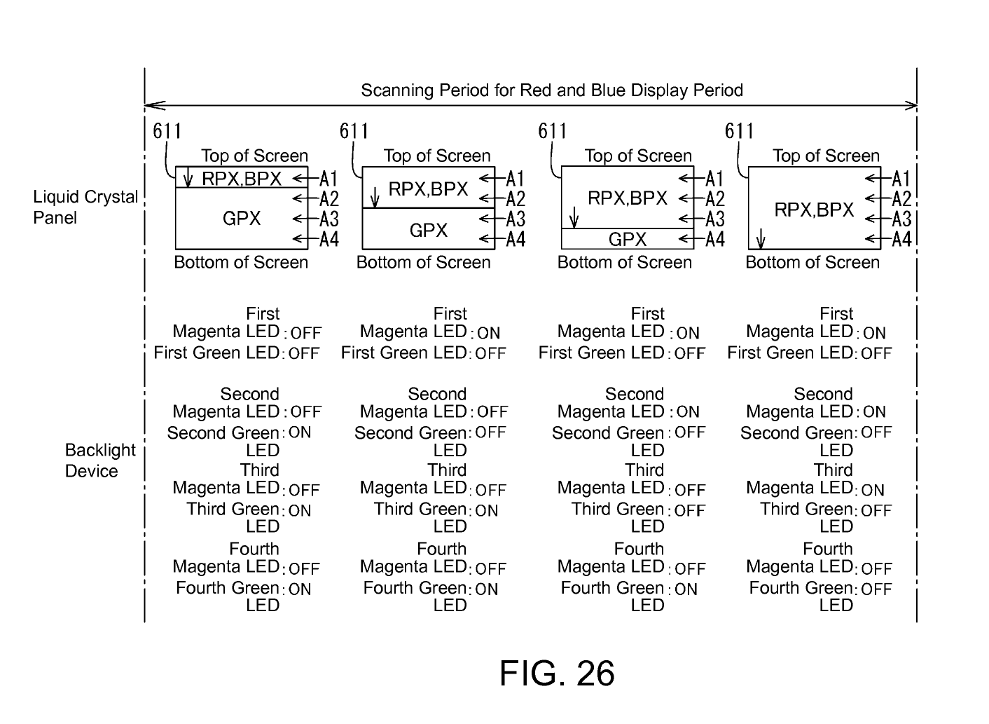

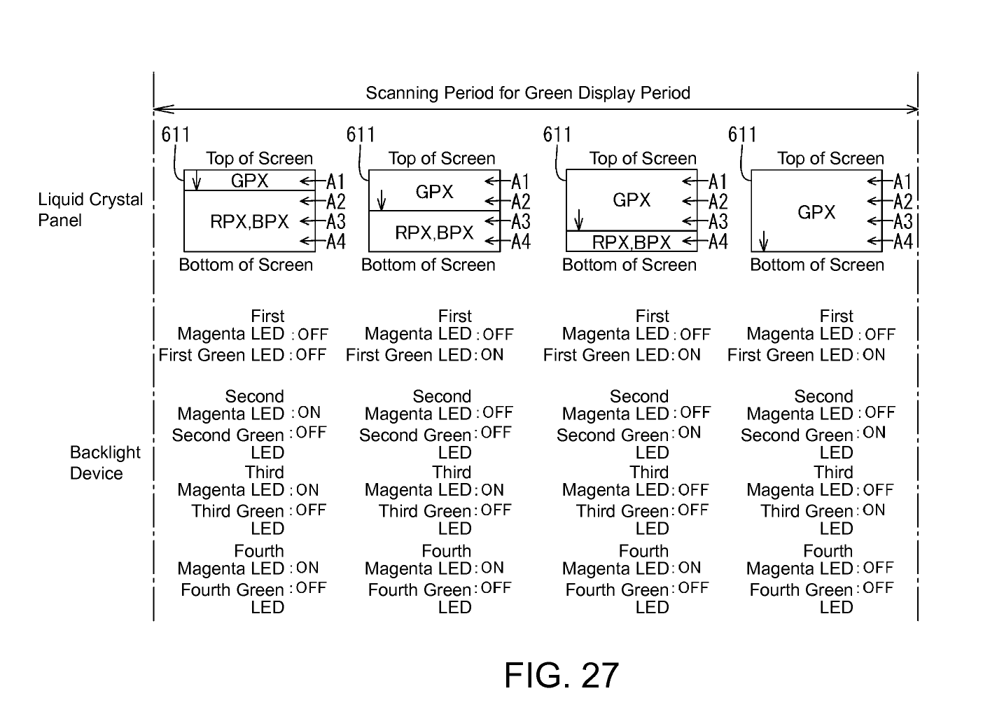

Next, the controlling of the backlight device 612 will be described with reference to FIGS. 26 and 27. In FIG. 26, the scanning period of the red-and-blue display period is divided into four periods. Specifically, the left end of FIG. 26 shows the period from when scanning of the red pixels RPX and the blue pixels BPX belonging to the first region A1 starts to when this scanning ends (first quarter of the scanning period of the red-and-blue display period), the second from left of FIG. 26 shows the period from when scanning of the red pixels RPX and the blue pixels BPX belonging to the second region A2 starts to when this scanning ends (second quarter of the scanning period of the red-and-blue display period), the third from the left of FIG. 26 shows the period from when scanning of the red pixels RPX and the blue pixels BPX belonging to the third region A3 starts to when this scanning ends (third quarter of the scanning period of the red-and-blue display period), and the right end of FIG. 26 shows the period from when scanning of the red pixels RPX and the blue pixels BPX belonging to the fourth region A4 starts to when this scanning ends (fourth quarter of the scanning period of the red-and-blue display period). Meanwhile, in FIG. 27, the scanning period of the green display period is divided into four periods. Specifically, the left end of FIG. 27 shows the period from when scanning of the green pixels GPX belonging to the first region A1 starts to when this scanning ends (first quarter of the scanning period of the green display period), and the second from left of FIG. 27 shows the period from when scanning of the green pixels GPX belonging to the second region A2 starts to when this scanning ends (second quarter of the scanning period of the green display period). The third from left of FIG. 27 shows the period from when scanning of the green pixels GPX belonging to the third region A3 starts to when this scanning ends (third quarter of the scanning period of the green display period), and the right end of FIG. 27 shows the period from when scanning of the green pixels GPX belonging to the fourth region A4 starts to when this scanning ends (fourth quarter of the scanning period of the green display period). The scanning of the pixels RPX, GPX, and BPX is performed sequentially in the Y axis direction, or in other words, the top of the screen to the bottom of the screen along the arrow indicated in the liquid crystal panel 611 of FIGS. 25 and 26.

The backlight control unit controlling the backlight device 612 controls the driving of the LEDs 617G and 617M in the following manner in synchronization with the scanning of the respective regions A1 to A4. The backlight control unit turns OFF the first magenta LEDs 617M1 and the first green LEDs 617G1 during the period from when scanning of the red pixels RPX and the blue pixels BPX belonging to the first region A1 starts during the red-and-blue display period to when this scanning ends (leftmost period of FIG. 26), whereas the backlight control unit turns ON the first magenta LEDs 617M1 while turning OFF the first green LEDs 617G1 during the period from when this scanning ends to when the scanning of the subsequent green display period starts (until the leftmost period of FIG. 27), or in other words, the period during which scanning of the red pixels RPX and the blue pixels BPX belonging to the second region A2 to the fourth region A4 starts during the red-and-blue display period (second from left period, third from left period, and rightmost period of FIG. 26, in that order). Next, the backlight control unit turns OFF the second magenta LEDs 617M2 and the second green LEDs 617G2 during the period from when scanning of the red pixels RPX and the blue pixels BPX belonging to the second region A2 starts during the red-and-blue display period to when this scanning ends (second from left period of FIG. 26), whereas the backlight control unit turns ON the second magenta LEDs 617M2 while turning OFF the second green LEDs 617G2 during the period from when this scanning ends to when the scanning of the subsequent green display period starts (until the second from left period of FIG. 27), or in other words, the period during which scanning of the red pixels RPX and the blue pixels BPX belonging to the third region A3 and the fourth region A4 starts during the red-and-blue display period to when scanning of the green pixels GPX belonging to the first region A1 starts during the green display period (third from left period, rightmost period, and leftmost period of FIG. 27, in that order).

Next, the backlight control unit turns OFF the third magenta LEDs 617M3 and the third green LEDs 617G3 during the period from when scanning of the red pixels RPX and the blue pixels BPX belonging to the third region A3 starts during the red-and-blue display period to when this scanning ends (third from left period of FIG. 26), whereas the backlight control unit turns ON the third magenta LEDs 617M3 while turning OFF the third green LEDs 617G3 during the period from when this scanning ends to when the scanning of the subsequent green display period starts (until the third from left period of FIG. 27), or in other words, the period during which scanning of the red pixels RPX and the blue pixels BPX belonging to the fourth region A4 starts during the red-and-blue display period to when scanning of the green pixels GPX belonging to the first region A1 and the second region A2 starts during the green display period (rightmost period of FIG. 26, leftmost period of FIG. 27, and second from left period of FIG. 27, in that order). Then, the backlight control unit turns OFF the fourth magenta LEDs 617M4 and the fourth green LEDs 617G4 during the period from when scanning of the red pixels RPX and the blue pixels BPX belonging to the fourth region A4 starts during the red-and-blue display period to when this scanning ends (rightmost period of FIG. 26), whereas the backlight control unit turns ON the fourth magenta LEDs 617M4 while turning OFF the fourth green LEDs 617G4 during the period from when this scanning ends to when the scanning of the subsequent green display period starts (until the rightmost period of FIG. 27), or in other words, the period during which scanning of the green pixels GPX belonging to the first region A1 to the third region A3 starts during the green display period (leftmost period of FIG. 27, second from left period of FIG. 27, and third from left period of FIG. 27, in that order). The red-and-blue display period of the first region A1 is the period when the first magenta LEDs 617M1 are illuminated (from second from left period to rightmost period of FIG. 26), the red-and-blue display period of the second region A2 is the period when the second magenta LEDs 617M2 are illuminated (third from left period of FIG. 26, rightmost period of FIG. 26, and leftmost period of FIG. 27, in that order), the red-and-blue display period of the third region A3 is the period when the third magenta LEDs 617M3 are illuminated (rightmost period of FIG. 26, leftmost period of FIG. 27, and second from left period of FIG. 27), and the red-and-blue display period of the fourth region A4 is the period when the fourth magenta LEDs 617M4 are illuminated (leftmost period to the third from left period of FIG. 27).

In this manner, the pixels RPX, GPX, and BPX belonging to the respective regions A1 to A4 are supplied magenta light from the magenta LEDs 617M1 to 617M4 from when the scanning of the red-and-blue display period ends to when the scanning of the subsequent green display period starts, thereby displaying red and blue in the display surface of the liquid crystal panel 611. In the regions A1 to A4, during the period from when the scanning of the red-and-blue display period starts to when the scanning ends, the LEDs 617G1 to 617G4, and 617M1 to 617M4, which can supply light to the respective regions A1 to A4 where scanning is performed, are turned OFF, and thus, light is prevented from entering the respective pixels RPX, GPX, and BPX in the middle of scanning. Thus, the color purity of light transmitted through the pixels RPX, GPX, and BPX is made higher, and the color reproduction is excellent. Furthermore, the illumination period of the magenta LEDs 617M1 to 617M4 is ¾ of the entire red-and-blue display period, which is longer than that of Embodiment 1, thereby allowing for an improved luminance.

Meanwhile, the panel control unit turns OFF the first magenta LEDs 617M1 and the first green LEDs 617G1 from when scanning of the green pixels GPX belonging to the first region A1 starts during the green display period to when this scanning ends (leftmost period of FIG. 27), whereas the panel control unit turns ON the first green LEDs 617G1 while turning OFF the first magenta LEDs 617M1 during the period from when this scanning ends to when the scanning of the subsequent red-and-blue display period starts (until the leftmost period of FIG. 26), or in other words, when the green pixels GPX belonging to the second region A2 to the fourth region A4 are scanned during the green display period (second from left period, third from left period, and rightmost period of FIG. 27). Next, the panel control unit turns OFF the second magenta LEDs 617M2 and the second green LEDs 617G2 from when scanning of the green pixels GPX belonging to the second region A2 starts during the green display period to when this scanning ends (second from left period of FIG. 27), whereas the panel control unit turns ON the second green LEDs 617G2 while turning OFF the second magenta LEDs 617M2 during the period from when this scanning ends to when the scanning of the subsequent red-and-blue display period starts (until the second from left period of FIG. 26), or in other words, when the green pixels GPX belonging to the third region A3 and the fourth region A4 are scanned during the green display period to when the red pixels RPX and the blue pixels BPX belonging to the first region A1 are scanned during the red-and-blue display period (third from left period in FIG. 27, rightmost period in FIG. 27, and leftmost period of FIG. 26).

Next, the panel control unit turns OFF the third magenta LEDs 617M3 and the third green LEDs 617G3 from when scanning of the green pixels GPX belonging to the third region A3 starts during the green display period to when this scanning ends (third from left period of FIG. 27), whereas the panel control unit turns ON the third green LEDs 617G3 while turning OFF the third magenta LEDs 617M3 during the period from when this scanning ends to when the scanning of the subsequent red-and-blue display period starts (until the third from left period of FIG. 26), or in other words, when the green pixels GPX belonging to the fourth region A4 are scanned during the green display period to when the red pixels RPX and the blue pixels BPX belonging to the first region A1 and the second region A2 are scanned during the red-and-blue display period (rightmost period in FIG. 27, leftmost period in FIG. 26, and second from left period of FIG. 26). Then, the panel control unit turns OFF the fourth magenta LEDs 617M4 and the fourth green LEDs 617G4 from when scanning of the green pixels GPX belonging to the fourth region A4 starts during the green display period to when this scanning ends (rightmost period of FIG. 27), whereas the panel control unit turns ON the fourth green LEDs 617G4 while turning OFF the fourth magenta LEDs 617M4 during the period from when this scanning ends to when the scanning of the subsequent red-and-blue display period starts (until the rightmost period of FIG. 26), or in other words, when the red pixels RPX and the blue pixels BPX belonging to the first region A1 to the third region A3 are scanned during the red-and-blue display period (leftmost period, second from left period, and third from left period of FIG. 26). The green display period in the first region A1 is a period during which the first green LEDs 617G1 are turned ON (second from left period to rightmost period of FIG. 27), the green display period in the second region A2 is a period during which the second green LEDs 617G2 are turned ON (third from left period of FIG. 27, rightmost period of FIG. 27, and leftmost period of FIG. 26), the green display period in the third region A3 is a period during which the third green LEDs 617G3 are turned ON (rightmost period of FIG. 27, the leftmost period of FIG. 26, and the second from left period of FIG. 26), and the green display period in the fourth region A4 is a period during which the fourth green LEDs 617G4 are turned ON (leftmost period to third from left period of FIG. 26).

In this manner, the respective pixels RPX, GPX, and BPX belonging to the regions A1 to A4 are supplied green light from the green LEDs 617G1 to 617G4 from when the scanning of the green display period ends to when the scanning of the subsequent red-and-blue display period starts, and thus, green display is performed on the display surface of the liquid crystal panel 611. In the regions A1 to A4, during the period from when the scanning of the green display period starts to when the scanning ends, the LEDs 617G1 to 617G4, and 617M1 to 617M4, which can supply light to the respective regions A1 to A4 where scanning is performed, are turned OFF, and thus, light is prevented from entering the respective pixels RPX, GPX, and BPX in the middle of scanning. Thus, the color purity of light transmitted through the pixels RPX, GPX, and BPX is made higher, and the color reproduction is excellent. Furthermore, the period during which the green LEDs 617G1 to 617G4 are turned ON takes up ¾ of the total green display period, which is longer than that of Embodiment 1, and thus, luminance can be improved.

As described above, in the present embodiment, the backlight device 612 has therein a plurality of magenta LEDs 617M and green LEDs 617G arranged in a matrix along a plane parallel to the surface of the liquid crystal panel 611 such that the light-emitting surfaces of the magenta LEDs 617M and the green LEDs 617G face the surface of the liquid crystal panel 611. Among the magenta LEDs 617M and the green LEDs 617G, the first magenta LEDs 617M1 and the first green LEDs 617G1 correspond in position to the first region A1 in a plan view, and the second magenta LEDs 617M2 and the second green LEDs 617G2 correspond in position to the second region A2. In this manner, the first region A1 can efficiently receive light from the first magenta LEDs 617M1 and the first green LEDs 617G1 corresponding in position to the first region A1 in a plan view, and it is unlikely for light from the second magenta LEDs 617M2 or the second green LEDs 617G2 to be mixed in. Similarly, the second region A2 can efficiently receive light from the second magenta LEDs 617M2 and the second green LEDs 617G2 corresponding in position to the second region A2 in a plan view, and it is unlikely for light from the first magenta LEDs 617M1 or the first green LEDs 617G1 to be mixed in. This presents the advantage that light from the LEDs 617G and 617M can be selectively supplied to the respective regions A1 and A2. This is particularly useful when dividing the liquid crystal panel 611 into many regions.

Also, the liquid crystal panel 611 is divided into three or more regions A1 to A4 in the column direction, while the backlight device 612 has magenta LEDs 617M and green LEDs 617G of three or more types that respectively supply light to the three or more regions A1 to A4. In this manner, compared to a case in which the liquid crystal panel is divided into two regions as in Embodiment 4, the illumination period of the respective LEDs 617G1 to G4 and 617M1 to M4 that supply light to the respective regions A1 to A4 of the liquid crystal panel 611 is long, and thus, the luminance can be improved compared to Embodiment 4.

### Embodiment 8

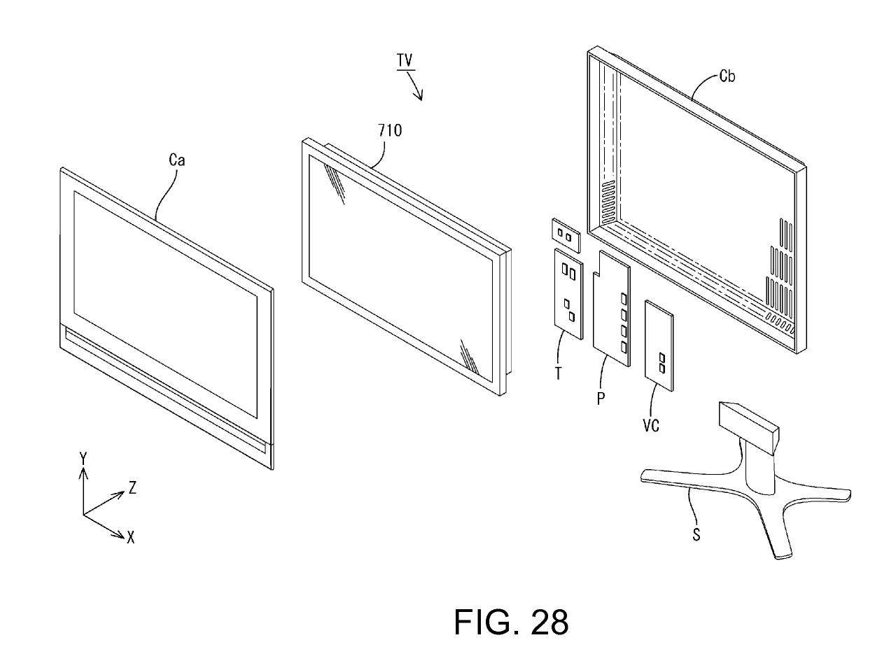

Embodiment 8 of the present invention will be described with reference to FIGS. 28 to 31. In Embodiment 8, the number of colors of color filters 729 in a liquid crystal panel 711 is increased from three to four colors. Descriptions of structures, operations, and effects similar to those of Embodiment 1 will be omitted.

As shown in FIG. 28, a television receiver TV and a liquid crystal display device 710 of the present embodiment include an image conversion circuit substrate VC that converts a television image signal outputted from a tuner T to an image signal for the liquid crystal display device 710. Specifically, the image conversion circuit substrate VC can convert the television image signal outputted from the tuner T to blue, green, red, and yellow image signals, and output the generated image signals of the respective colors to a control substrate connected to the liquid crystal panel 711.

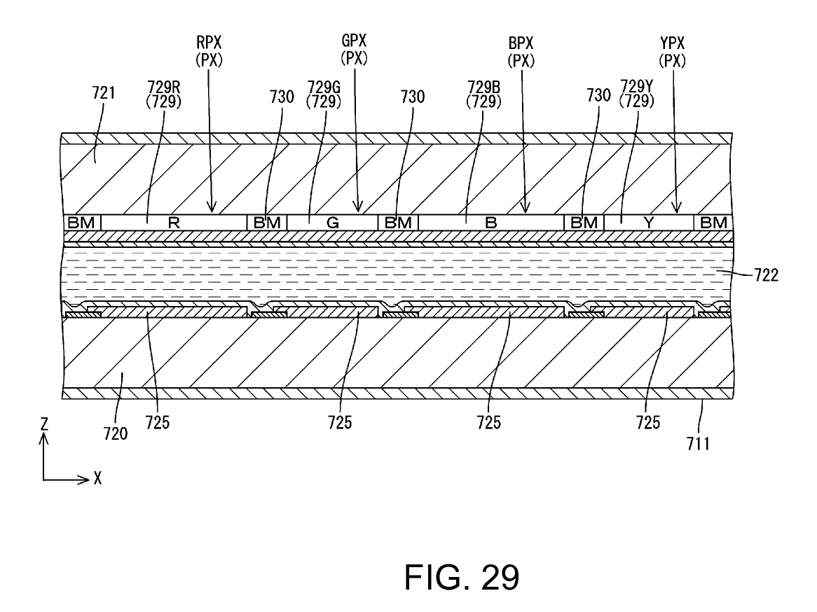

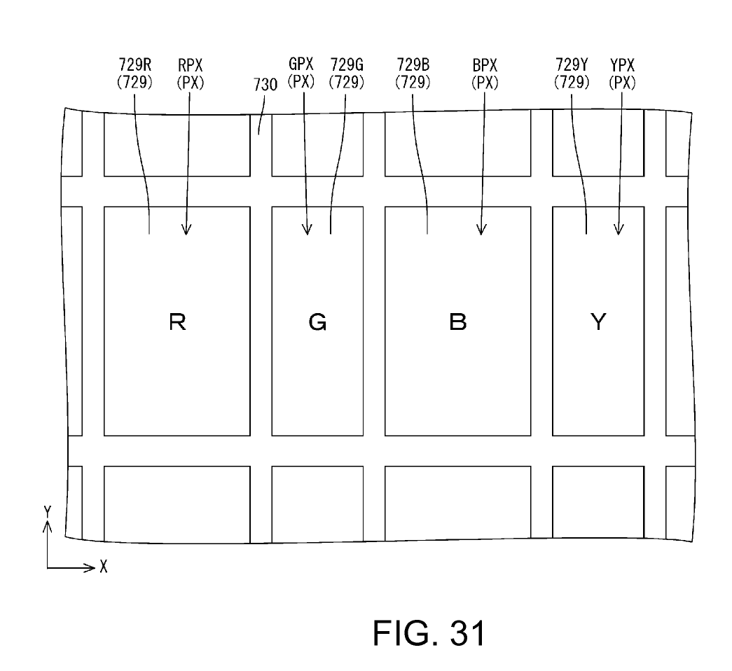

As shown in FIGS. 29 and 31, the inner surface of a CF substrate 721 of the liquid crystal panel 711, or in other words, the surface facing the liquid crystal layer 722 (surface opposing an array substrate 720) has disposed thereon color filters 729 arranged in a matrix and including a plurality of colored portions 729R, 729G, 729B, and 729Y corresponding to respective pixel electrodes 725 on the array substrate 720. The color filters 729 of the present embodiment has, in addition to the red colored portions 729R, the green colored portions 729G, and the blue colored portions 729B constituting the three primary colors of light, yellow colored portions 729Y that are colored yellow, and the color filters 729 can selectively allow through light of the respective colors (respective wavelengths) corresponding to the colored portions 729R, 729G, 729B, and 729Y. Specifically, the yellow colored portions 729Y selectively allow through light in the yellow wavelength region (approximately 570 nm to approximately 600 nm), or in other words, yellow light. The colored portions 729R, 729G, 729B, and 729Y each have a vertically long rectangular shape with the longer side direction matching the Y axis direction and the shorter side direction matching the X axis direction, in a manner similar to the pixel electrodes 725. In order to prevent color mixing, a grid pattern light-shielding layer 730 is provided between the colored portions 729R, 729G, 729B, and 729Y.

The arrangement and size of the respective colored portions 729R, 729G, 729B, and 729Y among the color filters 729 will be described in detail. As shown in FIG. 31, the respective colored portions 729R, 729G, 729B, and 729Y are arranged in a matrix such that the X axis direction is the row direction and the Y axis direction is the column direction. The column direction dimensions (Y axis direction) of the respective colored portions 729R, 729G, 729B, and 729Y are all the same, whereas the row direction dimensions (X axis direction) of the respective colored portions 729R, 729G, 729B, and 729Y differ from each other. Specifically, the colored portions 729R, 729G, 729B, and 729Y are arranged in the order of the red colored portion 729R, the green colored portion 729G, the blue colored portion 729B, and the yellow colored portion 729Y from the left of FIG. 31, and of these, the red colored portions 729R and the blue colored portions 729B have a larger row direction dimension than the yellow colored portions 729Y and the green colored portions 729G. In other words, the colored portions 729R and 729B having a relatively large row direction dimension are disposed alternately with the colored portions 729G and 729Y having a relatively small row direction dimension. As a result, the areas of the red colored portions 729R and the blue colored portions 729B are larger than the areas of the green colored portions 729G and the yellow colored portions 729Y. The area of the blue colored portion 729B is the same as the area of the red colored portion 729R. Similarly, the area of the green colored portion 729G is the same as the area of the yellow colored portion 729Y. In FIGS. 29 and 31, the area of the red colored portion 729R and the blue colored portion 729B is approximately 1.6 times that of the yellow colored portion 729Y and the green colored portion 729G.

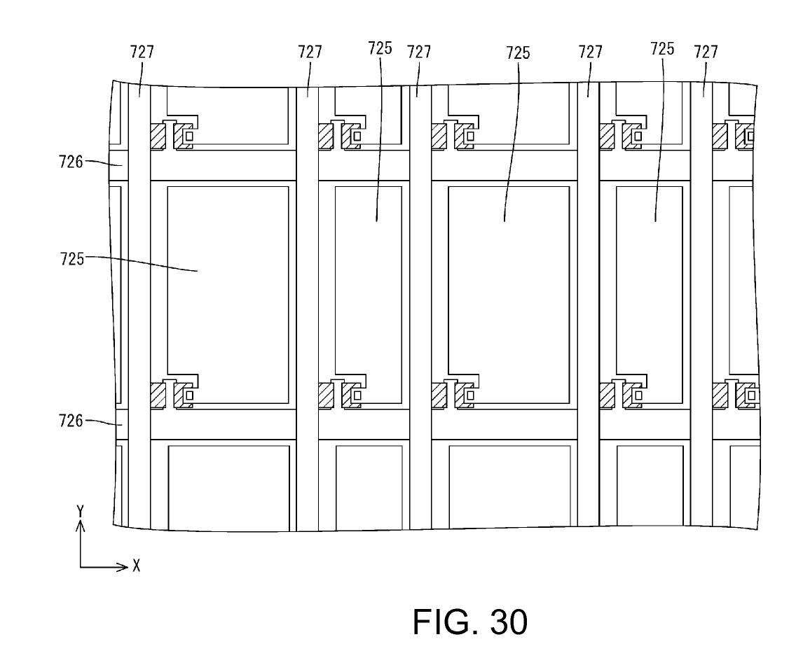

To correspond to such a configuration of color filters 729, as shown in FIG. 30, the row direction dimensions (X axis direction) of the pixel electrodes 725 on the array substrate 720 differ from each other. That is, among the pixel electrodes 725, those that correspond in position to the red colored portions 729R and the blue colored portions 729B have a larger row direction dimension and area compared to those that correspond in position to the yellow colored portions 729Y and the green colored portions 729G. In the liquid crystal panel 711, a yellow pixel YPX is constituted of a combination of the yellow colored portion 729Y and an opposing pixel electrode 725. In other words, the unit pixels PX of the liquid crystal panel include the red pixels RPX, the blue pixels BPX, the green pixels GPX, and the yellow pixels YPX. The gate wiring lines 726 are all arranged at an equal pitch, while the source wiring lines 727 are arranged at two different pitches corresponding to the sizes of the pixel electrodes 725 in the row direction. In the present embodiment, the auxiliary capacitance wiring lines are not shown.

The liquid crystal panel 711 having such a configuration is driven by receiving signals from a control substrate that is not shown. The control substrate is designed to receive image signals of blue, green, red, and yellow, which are generated by the image conversion circuit substrate VC shown in FIG. 28 converted television signals outputted from the tuner T. Thus, in the liquid crystal panel 711, the amount of light allowed through the respective colored portions 729R, 729G, 729B, and 729Y is appropriately controlled. In addition to the colored portions 729R, 729G, and 729B constituting the three primary colors of light, the color filters 729 of the liquid crystal panel 711 further include yellow colored portions 729Y, and thus, the color gamut of images displayed by the transmitted light can be expanded, and thus, images having excellent color reproduction can be displayed. Furthermore, light passing through the yellow colored portions 729Y has a wavelength close to the peak in luminosity, and thus, human eyes can perceive this color as being bright even if a small amount of energy is used to emit this light. As a result, even if the power output of the LEDs in the backlight device is reduced, sufficient brightness can be attained, thereby achieving effects such as a reduction in power consumption of the LEDs, and thus, excellent environmental performance.

Specific controls for the liquid crystal panel 711 and the backlight device will be described. The panel control unit controls the liquid crystal panel 711 so as to include a red, blue, and yellow display period during which red pixels RPX, blue pixels BPX, and yellow pixels YPX are selectively driven to display red, blue, and yellow light, and a green-and-yellow display period during which green pixels GPX and yellow pixels YPX are selectively driven to display green and yellow. Meanwhile, the backlight control unit controls the backlight device so as to turn ON magenta LEDs and turn OFF green LEDs during the red, blue, and yellow display period, while turning ON the green LEDs and turning OFF the magenta LEDs during the green-and-yellow display period. The configuration of the backlight device is the same as that described in Embodiment 1.

### Embodiment 9

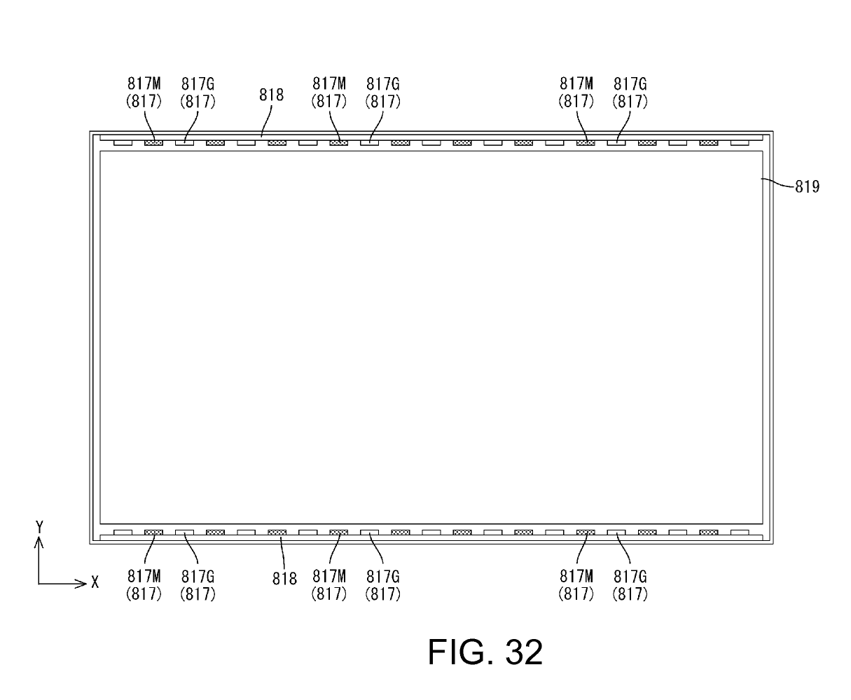

Embodiment 9 of the present invention will be described with reference to FIG. 32. In Embodiment 9, the arrangement of LEDs 817 on LED substrates 818 is modified as compared to Embodiment 1. Descriptions of structures, operations, and effects similar to those of Embodiment 1 will be omitted.

As shown in FIG. 32, the LEDs 817 of the present embodiment are arranged on the pair of LED substrates 818 with the light guide plate 819 therebetween so as to be symmetrical up and down. In other words, on the pair of LED substrates 818, the magenta LEDs 817M and the green LEDs 817G are alternately arranged such that the magenta LEDs 817M mounted on one LED substrate 818 are in the same position in the X axis direction as the magenta LEDs 817M mounted on the other LED substrate 818 (opposing each other in the Y axis direction across the light guide plate 819), and the green LEDs 817G mounted on the one LED substrate 818 are in the same position in the X axis direction as the green LEDs 817G mounted on the other LED substrate 818.

### Embodiment 10

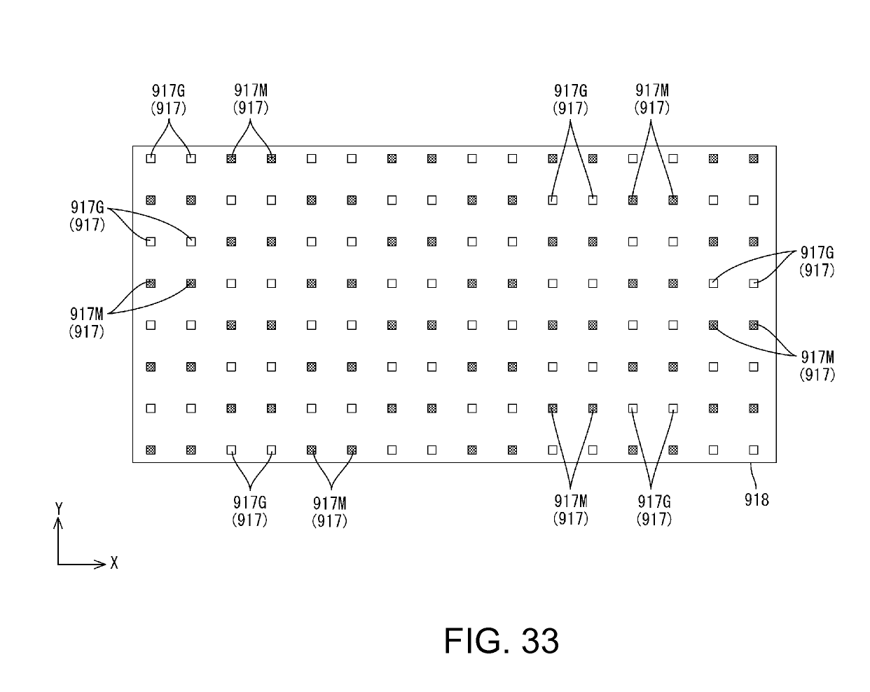

Embodiment 10 of the present invention will be described with reference to FIG. 33. In Embodiment 10, the arrangement of LEDs 917 on the LED substrate 918 is modified from that of Embodiment 7. Descriptions of structures, operations, and effects similar to those of Embodiment 7 will be omitted.

As shown in FIG. 33, the LEDs 917 of the present embodiment are arranged such that on the LED substrate 918, two of the same type of LEDs are disposed next to each other in the longer side direction (X axis direction), whereas in the shorter side direction (Y axis direction) the type of LEDs adjacent to each other are different. Specifically, on the LED substrate 917, two magenta LEDs 917M and two green LEDs 917G are alternately arranged in the X axis direction, whereas one magenta LED 917M and one green LED 917G are alternately arranged in the Y axis direction.

### Other Embodiments

The present invention is not limited to the embodiments shown in the drawings and described above, and the following embodiments are also included in the technical scope of the present invention, for example.

(1) In the respective embodiments above (except Embodiment 2), the magenta LEDs have a blue LED element and a red phosphor, but the specific types of LED element and phosphor can be modified as appropriate. For example, the magenta LED can include an ultraviolet LED element that emits ultraviolet light, a red phosphor that emits red light by being excited by the ultraviolet light from the ultraviolet LED element, and a blue phosphor that emits blue light by being excited by the ultraviolet light from the ultraviolet LED element.

(2) In the embodiments above (except Embodiment 2), the blue LED elements included in the magenta LEDs and the green LED elements included in the green LEDs are made of the same semiconductor material (InGaN), but the type of semiconductor material can differ between the blue LED elements and the green LED elements.

(3) In the embodiments above (except Embodiment 2), InGaN is used as the material for the LED elements of the LEDs, but other materials that can be used for the LED elements include, GaN, AlGaN, GaP, ZnSe, ZnO, AlGaInP, and the like, for example.

(4) In Embodiment 1, one magenta LED and one green LED are alternately disposed on the LED substrate, but two magenta LEDs and two green LEDs can be alternately disposed on the LED substrate. The specific arrangement of the magenta LEDs and the green LEDs can be appropriately modified, and in some cases, the number of magenta LEDs can differ from the number of green LEDs.

(5) In Embodiment 1, one LED substrate is provided along each light-receiving face of the light guide plate, the present invention also includes an arrangement in which two or more LED substrates are disposed along each light-receiving face of the light guide plate.

(6) In Embodiment 1, the LED substrates face the pair of side long side faces of the light guide plate, but the present invention also includes an arrangement in which the LED substrates face the pair of short side faces of the light guide plate. The present invention also includes a configuration in which an LED substrate is provided along one long side face of the light guide plate or one short side face of the light guide plate.

(7) Besides the configuration of (6), the present invention also includes an arrangement in which LED substrates are provided on three arbitrary side faces of the light guide plate, and an arrangement in which LED substrates are provided on all four side faces of the light guide plate.

(8) In Embodiment 3, the frame rate conversion circuit doubles the frame rate of the output signal processed in the image signal processing circuit, but the present invention also includes a case in which the frame rate conversion circuit quadruples the frame rate of the output signal processed in the image signal processing circuit.

(9) In Embodiment 4, a case was described in which the liquid crystal panel is divided into two regions, and the driving of the magenta LEDs and green LEDs in the edge lit backlight device radiating light to the respective regions is synchronized with the driving of the pixels belonging to the respective regions, but it is also possible to divide the liquid crystal panel into three or more regions and drive in the magenta LEDs and green LEDs radiating light to the three or more regions in synchronization with the driving of the pixels belonging to the respective regions. In such a case, it is preferable that a configuration that guarantees optical isolation of the magenta LEDs and the green LEDs be additionally provided.

(10) As light sources of the backlight device of Embodiment 4, it is also possible to use red LEDs, blue LEDs, and green LEDs as in Embodiment 2. In such a case, the “magenta LEDs” of Embodiment 4 can be read as “red LEDs and blue LEDs.”

(11) In Embodiment 6, the red colored portions and the blue colored portions among the color filters are made thinner than the green colored portions, but similar effects can be attained even if the concentration of pigment in the red colored portions and the blue colored portions were made less than the concentration of pigment in the green colored portion. In such a case, the red colored portions and the blue colored portions can be made to be substantially the same thickness as the green colored portions.

(12) In Embodiment 7, a case was described in which the liquid crystal panel is divided into four regions and the respective magenta LEDs and green LEDs in the direct lit backlight device are driven in synchronization with the pixels belonging to the respective regions, but it is also possible to divide the liquid crystal panel into three or fewer regions or five or more regions, with the magenta LEDs and the green LEDs radiating light to the three or fewer or five or more regions being driven in synchronization with the pixels belonging to the respective regions. Compared to an edge lit backlight device, direct lit backlight devices are advantageous in that the liquid crystal panel and the number of groups of LEDs can be increased with ease.

(13) The direct lit backlight device of Embodiment 7 may be driven without dividing the liquid crystal panel into regions or the LEDs into groups, in a manner similar to Embodiment 1.

(14) As light sources of the backlight device of Embodiment 7, it is also possible to use red LEDs, blue LEDs, and green LEDs as in Embodiment 2. In such a case, the “magenta LEDs” of Embodiment 7 can be read as “red LEDs and blue LEDs.”

(15) In Embodiments 7 and 10, one or two of the magenta LEDs and green LEDs are alternately disposed on the LED substrate, but three or more of the magenta LEDs and green LEDs can be alternately disposed. The specific arrangement of the magenta LEDs and the green LEDs can be appropriately modified, and in some cases, the number of magenta LEDs can differ from the number of green LEDs.

(16) In Embodiment 8, the area taken up by the blue colored portions and red colored portions among the color filters is different from the area taken up by the green colored portions and the yellow colored portions, but the areas taken up by the blue colored portions, the red colored portions, the green colored portions, and the yellow colored portions can be the same. The area taken up by the blue colored portions can be different from that of the red colored portions. Similarly, the area taken up by the green colored portions can be different from that of the yellow colored portions. In the respective embodiments, the order and area of the colored portions among the color filters can be appropriately modified.

(17) As light sources of the backlight devices of Embodiments 3, 5, 6, and 8 to 10, the red LEDs, blue LEDs, and green LEDs of Embodiment 2 can be used. In such a case, the “magenta LEDs” of Embodiments 3, 5, 6, and 8 to 10 can be read as “red LEDs and blue LEDs.”

(18) In the respective embodiments above, LEDs were used as the light source, but other types of light source such as an organic EL element may also be used.

(19) In the respective embodiments above, TFTs are used as the switching element in the liquid crystal display device, but the present invention can be applied to a liquid crystal display device that uses a switching element other than a TFT (a thin film diode (TFD), for example), and, besides a color liquid crystal display device, the present invention can also be applied to a black and white liquid crystal display device.

(20) In the respective embodiments above, a liquid crystal display device using a liquid crystal panel as a display panel was described as an example, but the present invention can be applied to a display device that uses another type of display panel.

(21) In the respective embodiments above, a television receiver that includes a tuner was illustratively shown, but the present invention is also applicable to a display device without a tuner. Specifically, the present invention may also be applied to digital signage and electronic black boards.

Description of Reference Characters
10, 610, 710 liquid crystal display device (display device)
11, 111, 211, 311, 511, 611, 711 liquid crystal panel (display panel)
12, 112, 312, 612 backlight device (illumination device)
17G, 317G, 617G, 817G, 917G green LED (green light source)
17M, 317M, 617M, 817M, 917M magenta LED (magenta light source)
20, 520, 720 array substrate (substrate)
21, 521, 721 CF substrate (substrate)
22, 522, 722 liquid crystal layer (liquid crystal material)
29, 429, 529, 729 color filter
29B, 429B, 529B, 729B blue colored portion
29G, 529G, 729G green colored portion
29R, 429R, 529R, 729R red colored portion
40B blue LED element (blue light-emitting element)
40G green LED element (green light-emitting element)
50, 250 panel control unit
51 backlight control unit (illumination control unit)
52, 252 image signal processing circuit
53, 253 pixel driving unit
56 frame rate conversion circuit
117B blue LED (blue light source, magenta light source)
117R red LED (red light source, magenta light source)
317G1, 617G1 first green LED (first green light source)
317M1, 617M1 first magenta LED (first magenta light source)
317G2, 617G2 second green LED (second green light source)
317M2, 617M2 second magenta LED (second magenta light source)
A1 first region
A2 second region
BPX blue pixel
GPX green pixel
RPX red pixel

TPX transparent pixel (green pixel)

TV television receiver

1. A display device, comprising:
a display panel, for displaying images, having red pixels that selectively allow through red light, blue pixels that selectively allow through blue light, and green pixels that selectively allow through at least green light;
an illumination device for supplying light for image display to the display panel, the illumination device having magenta light sources that emit magenta light, and green light sources that emit green light;
a panel control unit that controls the display panel such that each frame period includes a red-and-blue display period during which the red pixels and the blue pixels are selectively driven to display red and blue, and a green display period during which the green pixels are selectively driven to display green; and
an illumination control unit that controls the illumination device such that the magenta light sources are turned on and the green light sources are turned off during the red-and-blue display period, and such that the green light sources are turned on and the magenta light sources are turned off during the green display period.

2. The display device according to claim 1, wherein the green pixels selectively allow through green light.

3. The display device according to claim 1, wherein the magenta light sources each have a blue light-emitting element that emits blue light and a red phosphor that emits red light by being excited by the blue light emitted by the blue light-emitting element.

4. The display device according to claim 3,
wherein the green light sources each have a green light-emitting element that emits green light, and
wherein the green light-emitting element in each of the green light sources is made of a same semiconductor material as the blue light-emitting element in each of the magenta light sources.

5. The display device according to claim 4, wherein the semiconductor material is InGaN.

6. The display device according to claim 1,
wherein the display panel has a plurality of the red pixels, the green pixels, and the blue pixels arranged in a matrix, and the panel control unit sequentially scans, in a column direction, groups of pixels including the red pixels, the green pixels, and the blue pixels arranged in a row direction on the display panel,
wherein the display panel is divided into at least two regions including a first region that is relatively close in the column direction to where scanning starts and a second region that is relatively far in the column direction from where scanning starts, and the magenta light sources and the green light sources in the illumination device are separated into at least two types including first magenta light sources and first green light sources that supply light to the first region in the column direction, and second magenta light sources and second green light sources that supply light to the second region,
wherein the illumination control unit turns off the first magenta light sources and the first green light sources from when scanning of the red pixels and the blue pixels or the green pixels belonging to the first region starts to when the scanning ends during the red-and-blue display period or the green display period, while the illumination control unit turns on either of the first magenta light sources and the first green light sources and turns off another of the first green light sources and the first magenta light sources from when said scanning ends to when scanning starts during the subsequent green display period or the subsequent red-and-blue display period, and
wherein the illumination control unit turns off the second magenta light sources and the second green light sources from when scanning of the red pixels and the blue pixels or the green pixels belonging to the second region starts to when the scanning ends during the red-and-blue display period or the green display period, while the illumination control unit turns on either of the second magenta light sources and the second green light sources and turns off another of the second green light sources and the second magenta light sources from when said scanning ends to when scanning starts during the subsequent green display period or the subsequent red-and-blue display period.

7. The display device according to claim 6,
wherein, in the illumination device, a plurality of the magenta light sources and a plurality of the green light sources are arranged in a matrix such that respective light-emitting surfaces thereof face a surface of the display panel, the plurality of magenta light sources and a plurality of the green light sources being arranged along said surface, and
wherein the magenta light sources and the green light sources are arranged such that the first magenta light sources and the first green light sources correspond in position to the first region in a plan view, and such that the second magenta light sources and the second green light sources correspond in position to the second region in a plan view.

8. The display device according to claim 7, wherein the display panel is divided into three or more regions in the column direction, and in the illumination device, the magenta light sources and the green light sources are separated into three or more types that respectively supply light to the three or more regions of the display panel.

9. The display device according to claim 1, wherein the panel control unit includes an image signal processing circuit that processes image signals, a pixel driving unit that drives the red pixels, the green pixels, and the blue pixels on the basis of signals outputted from the image signal processing circuit, and a frame rate conversion circuit that can convert a frame rate of the signals outputted from the image signal processing circuit and supply said signals to the pixel driving unit.

10. The display device according to claim 1,
wherein the display panel includes a substance between a pair of substrates that changes optical properties in response to an applied electric field, and either one of the pair of substrates has color filters including at least red colored portions that are colored red, green colored portions that are colored green, and blue colored portions that are colored blue,
wherein the red pixels have the red colored portions, the green pixels have the green colored portions, and the blue pixels have the blue colored portions, and
wherein the red colored portions and the blue colored portions are thinner than the green colored portions.

11. The display device according to claim 1, wherein the magenta light sources each include a red light sources that emits red light and a blue light source that emits blue light.

12. The display device according to claim 1, wherein the green pixels are transparent pixels that allow through all visible light.

13. The display device according to claim 1, wherein the display panel is a liquid crystal panel including a pair of substrates with liquid crystal sealed therebetween.

14. A television receiver, comprising:
the display device according to claim 1.
